(19) United States
(12) Patent Application Publication
(10) Pub. No.: US 2025/0343747 A1
(43) Pub. Date: Nov. 6, 2025

(54) Systems and Methods for Generating Tunable Jitter

(71) Applicant: Kratos SRE, Inc., Birmingham, AL (US)

(72) Inventors: Seth Daniel Cohen, Vestavia, AL (US); Casey Martin Fendley, Pelham, AL (US)

(21) Appl. No.: 18/655,697

(22) Filed: May 6, 2024

(51) Int. Cl. H04L 43/087; H04L 7/00

(52) U.S. Cl. CPC H04L 43/087; H04L 7/0016

(57) ABSTRACT

Systems and method for generating tunable jitter are disclosed. The system can include a delay circuit having a plurality of stages and configured to receive an input signal. Each stage can include logical elements, and the delay circuit can be configured to transmit at least a first version of the input signal and a second version of the input signal through the stages such that the first version travels through a first path and the second version travels through a second path of the delay circuit. The system can include a controller that is configured to apply a number to the stages and the stages are configured to receive a portion of the number that controls which logical element of the respective stage processes the first and second versions. The system can include a combiner that combines the first version and the second version to form a jittered output signal.

### BACKGROUND

Modern electronic communication systems require a high degree of signal precision to effectively operate error-free. Generally, the faster a connection is, the lower is the tolerance of that connection to signal error in the form of jitter. Not only do communication systems suffer from signal errors, but any computing system (e.g., integrated circuits) that includes linked components in electronic communication may be susceptible to signal errors due to jitter. Accordingly, it is often desirable to test systems such as integrated circuits, computing devices, and communications systems for jitter tolerance prior to their deployment.

Indeed, current systems for generating jitter have numerous drawbacks. Bit error rate testers exist that are capable of generating and injecting jitter into a digital signal to determine a system's tolerance to jitter. However, many presently available jitter generators are external devices to the systems being tested, are extremely expensive, and require manufacturers to manually test components and communication systems to determine their jitter tolerances. Another drawback of many current jitter generators is that they are not capable of generating jitter that is normally distributed without tradeoffs between cost, discretization of the jitter, and added complexity.

The disclosed embodiments herein are directed to addressing these and other considerations.

### BRIEF DESCRIPTION OF THE DRAWINGS

The present disclosure can be better understood, by way of example only, with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1A depicts an exemplary tunable jitter generator applying jitter to an input data stream, according to aspects of the present disclosure.

FIG. 1B depicts an exemplary tunable jitter generator applying jitter to an input clock, according to aspects of the present disclosure.

FIG. 2A depicts an exemplary tunable jitter generator generating a first level of jitter, according to aspects of the present disclosure.

FIG. 2B depicts an exemplary tunable jitter generator generating a second level of jitter, according to aspects of the present disclosure.

FIG. 3 is an illustration of normally distributed jitter present on the rising and falling edges of an output from an exemplary tunable jitter generator, according to aspects of the present disclosure.

FIG. 4A is a block diagram depicting an input signal being delayed by a logical element, according to aspects of the present disclosure.

FIG. 4B is a graph depicting an input signal being delayed by a logical element, according to aspects of the present disclosure.

FIG. 5A is a block diagram depicting an input signal being delayed by a cascade of equivalent logical elements, according to aspects of the present disclosure.

FIG. 5B is a graph depicting an input signal being delayed by a cascade of equivalent logical elements, according to aspects of the present disclosure.

FIG. 6A is a block diagram depicting an input signal being delayed by a cascade of approximately equivalent logical elements, according to aspects of the present disclosure.

FIG. 6B is a graph depicting an input signal being delayed by a cascade of approximately equivalent logical elements, according to aspects of the present disclosure.

FIG. 7 depicts an Arbiter PUF for adding delay to a signal, according to aspects of the present disclosure.

FIG. 8A depicts an exemplary pair of delay paths generated by a first cascade of approximately equivalent logical elements, according to aspects of the present disclosure.

FIG. 8B depicts an exemplary pair of delay paths generated by a second cascade of approximately equivalent logical elements, according to aspects of the present disclosure.

FIG. 8C depicts an exemplary pair of delay paths generated by a third cascade of approximately equivalent logical elements, according to aspects of the present disclosure.

FIG. 9 depicts a simplified diagram of a pair of delay paths generated by a cascade of approximately equivalent logical elements, according to aspects of the present disclosure.

FIG. 10A depicts an exemplary single-stage jitter generator, according to aspects of the present disclosure.

FIG. 10B depicts a simplified diagram of the exemplary single-stage jitter generator of FIG. 10A, according to aspects of the present disclosure.

FIG. 10C depicts two jittered signals that are combined with an AND gate, according to aspects of the present disclosure.

FIG. 10D depicts two jittered signals that are combined with an OR gate, according to aspects of the present disclosure.

FIG. 11 depicts an exemplary two-stage tunable jitter generator, according to aspects of the present disclosure.

FIG. 12 depicts an exemplary multi-stage tunable jitter generator, according to aspects of the present disclosure.

FIG. 13A depicts an exemplary multi-stage tunable jitter generator that can be implemented on a FPGA, according to aspects of the present disclosure.

FIG. 13B depicts the FPGA architecture of a single stage of the multi-stage tunable jitter generator of FIG. 13A, according to aspects of the present disclosure.

FIG. 14A depicts jitter generated with exemplary tunable jitter generator having 20 and 30 generator stages, according to aspects of the present disclosure.

FIG. 14B depicts jitter generated with exemplary tunable jitter generator having 100, 200, 300, 400, and 500 generator stages, according to aspects of the present disclosure.

FIG. 15A depicts a stand-alone tunable jitter generator for providing jitter to a user-defined clock, according to aspects of the present disclosure.

FIG. 15B depicts a stand-alone tunable jitter generator for providing jitter to user-defined data, according to aspects of the present disclosure.

FIG. 15C depicts a stand-alone tunable jitter generator for providing jitter to a both a user-defined clock and user-defined data, according to aspects of the present disclosure.

FIG. 16 depicts a self-contained bit error rate tester with an integrated tunable jitter generator and combiner, according to aspects of the present disclosure.

FIG. 17 depicts an exemplary test output curve, from a bit error rate tester, according to aspects of the present disclosure.

FIG. 18 depicts a bit error rate tester with an integrated tunable jitter generator configured to use user-defined data as an input, according to aspects of the present disclosure.

FIG. 19 depicts a combiner and tunable jitter generator paired with a bit error rate tester configured to supply a data stream with and without jitter to evaluate the bit error rate of a test system, according to aspects of the present disclosure.

FIG. 20 depicts an integrated circuit with a built-in bit error rate tester, combiner, and tunable jitter generator configured for factory testing of a signal processor of the integrated circuit, according to aspects of the present disclosure.

FIG. 21 depicts an integrated circuit with selectable paths for adding jitter before or after a signal processor to evaluate the maximum acceptable jitter on an input and to add jitter to the output, according to aspects of the present disclosure.

FIG. 22 depicts a simulated analog to digital converter (ADC) that samples analog content and outputs digital bits, according to aspects of the present disclosure.

FIG. 23A depicts a simulated time series of a sine wave, according to aspects of the present disclosure.

FIG. 23B depicts a power spectral density (PSD) of the sine wave of FIG. 23A, according to aspects of the present disclosure.

FIG. 23C depicts a simulated time series of a sine wave with saturation of its amplitude, according to aspects of the present disclosure.

FIG. 23D depicts a PSD of the sine wave of FIG. 23C, according to aspects of the present disclosure.

FIG. 24A depicts a simulated time series of a sine wave, according to aspects of the present disclosure.

FIG. 24B depicts a power spectral density (PSD) of the sine wave of FIG. 24A, according to aspects of the present disclosure.

FIG. 24C depicts a time series of a mono-bit input with noise, according to aspects of the present disclosure.

FIG. 24D depicts a PSD of the mono-bit input of FIG. 24C, according to aspects of the present disclosure.

FIG. 25A depicts a simulated removal of spurs from amplifier saturation using jittered clock sampling, according to aspects of the present disclosure.

FIG. 25B depicts a comparison of the simulated removal of spurs from FIG. 25A and the PSD of the saturated sine wave as shown in FIG. 23D, according to aspects of the present disclosure.

FIG. 25C compares a real peak of the PSD output from the simulated saturated amplifier with jittered sampling and without jittered sampling, according to aspects of the present disclosure.

FIG. 25D compares a spurious peak of the PSD output from the simulated saturated amplifier without jittered sampling to the suppressed peak with jittered sampling, according to aspects of the present disclosure.

FIG. 26A depicts a simulated removal of spurs from mono-bit sampling using jittered clock sampling, according to aspects of the present disclosure.

FIG. 26B depicts a comparison of the simulated removal of spurs from FIG. 26A and the PSD of the mono-bit sine wave as shown in FIG. 24D, according to aspects of the present disclosure.

FIG. 26C compares a real peak of the PSD output from the simulated mono-bit sine wave with jittered sampling and without jittered sampling, according to aspects of the present disclosure.

FIG. 26D compares a spurious peak of the PSD output from the mono-bit sine wave without jittered sampling to the suppressed peak with jittered sampling, according to aspects of the present disclosure.

FIG. 27A depicts the PSD from the simulated mono-bit receiver using normally-distributed jitter, according to aspects of the present disclosure.

FIG. 27B depicts the PSD from the simulated mono-bit receiver using uniformly-distributed jitter, according to aspects of the present disclosure.

FIG. 28A depicts an FPGA converting a non-jittered clock into a jittered clock, according to aspects of the present disclosure.

FIG. 28B depicts an experimental mono-bit receiver on an FPGA that can sample mono-bit input using a both a jittered and non-jittered clock, according to aspects of the present disclosure.

FIG. 29 depicts the spectrums and waveforms generated by the experimental setup shown in FIG. 28B, according to aspects of the present disclosure.

### DETAILED DESCRIPTION

The present disclosure generally relates to systems and methods for generating tunable jitter. The disclosed systems utilize an architecture capable of generating tunable jitter that is normally (i.e., Gaussian) distributed. It should be noted that throughout this disclosure, the terms normally distributed and Gaussian distributed are used interchangeably. The disclosed systems are capable of being implemented on numerous platforms. For example, the disclosed systems can be integrated into an application specific integrated circuit (ASIC) to allow for chip testing before a product leaves the assembly line. In some examples, the proposed system can be implemented without analog components, and specifically can be implemented on a standard field programmable gate array (FPGA) that is programmed using software. Current tunable jitter generators often utilize analog design components, such as capacitors and voltage delay lines that make the jitter generator impossible to implement in an FPGA. Designs integrating such analog components typically need to be custom manufactured, which increases costs, design complexity, and difficulty in integrating such jitter generators into existing systems for testing purposes. In addition, jitter generators that include such components, while offering some tunability, cannot usually provide jitter that is normally distributed. Normally distributed jitter is critical for numerous applications, such as testing sensitive communication devices and interconnects, and aligning test results with theory and simulations. It can also be used to characterize the robustness of clock timing, phased-locked loops (PLLs), the timing of data converters (ADCs and DACs), and to create spread spectrum clock oscillators that can reduce electromagnetic interference.

In some embodiments of the present disclosure, an input signal is separately transmitted through different paths of a delay circuit such that multiple versions of the input signal experience slightly different delays due to process variations across the delay circuit. As an example, the path of a version of each input signal may be selected based on a random number such that a random delay is experienced by each signal version, and a combiner may combine the randomly delayed versions to generate a jittered output signal. Specifically, the combiner combines delayed signal versions such that there are time deviations in the signal transitions of the jittered output signal relative to the input signal.

In some examples, the random number used for path selection is a series of binary values (e.g., “1” or “0), also referred to as a binary vector. As will be further described below, this binary vector can be used to define two complementary delay line paths through a delay circuit composed of cascaded logical elements, where a value of “1” instructs the system to propagate the signal through one delay line and a value of “0” instructs the system to effectively cross wire the delay lines, sending the input signal through the complementary delay line. The output signals from each delay line can be understood as the sum of the delays of each logical element within each delay line. By iteratively generating different binary vectors, the delay of the output from each defined delay line can be varied due to manufacturing variations within each logical element.

In some examples of the present disclosure, the controller can generate a second random number which can be provided to the combiner. The combiner can be configured to combine the outputs from the paths of the delay circuit based on the second random number that is received from the controller. In some examples, the controller can generate the second random number as one or more binary register values having a value of either “1” or “0.” Each binary register value can instruct the combiner to apply either an AND (e.g., for a value of “1”) gate or an OR gate (e.g., for a value of “0”) to the output signals of the paths of the delay circuit. It should be understood that in other embodiments, the second random number may not be limited to binary values, and the combiner may be configured to apply other logical combinations using other types of gates (e.g., a XOR gate, a NOT gate, a NAND gate, a NOR gate, etc.) or hardware. The combination of the delay circuit and the combiner can be referred to herein as a “generator stage.”

In some examples of the present disclosure, the system can include multiple generator stages. That is, the output signal of a first generator stage can become an input signal into a second generator stage, which has its own paths that are selected by the controller (e.g., based on a random number). Similarly, the system can include a third generator stage, a fourth generator stage, and so on, up to an arbitrary number of generator stages. By sampling output signals from a plurality of generator stages, the disclosed tunable jitter generator can generate widely tunable and normally distributed jitter.

Some examples of the present disclosure allow for the tunable jitter generator to be constructed using transistor-only components. Although the present disclosure discusses tunable jitter generator systems that are implemented on FPGAs and various integrated circuits, it should be understood that the disclosed architecture is applicable to a variety of additional technologies. For example, a tunable jitter generator consistent with the disclosed embodiments can be applicable to optical communication systems and radio frequency communication systems. For example, in an optical system, optical components (e.g., optical crystals) can be used to create cascaded logical elements (e.g., optical Arbiter PUFs), thereby facilitating the creation of optical tunable jitter generation consistent with the disclosed embodiments. In an example RF system, tunable transmission lines (e.g., a coaxial cable) transmitting envelopes of RF signals can be used to create cascaded logical elements (e.g., RF Arbiter PUFs) which produce delayed outputs that, when combined with the combiner, thereby facilitate the creation of RF envelope tunable jitter generation consistent with the disclosed embodiments. In another example RF system, tunable transmission lines (e.g., a coaxial cable) transmitting RF signals (i.e., RF pulse sine waves) can be used to create cascaded logical elements (e.g., RF Arbiter PUFs) which produce delayed outputs that, when combined, facilitate creation of RF tunable jitter generation consistent with the disclosed embodiments. It should be noted that the when the combiner is used to generate tunable jitter generation on RF signals, the combiner may be configured to apply logical combinations to the delayed signals using methods other than AND gates and OR gates.

Embodiments of the disclosed technologies can be implemented in fully-electronic assemblies, including transistors; CMOS logic gates; field programmable gate-arrays (FPGAs); application-specific integrated circuits (ASICs); a combination of the foregoing; or similar. Assemblies that include FPGAs are highly practical platform for implementing the principles of this disclosure because, amongst other things, FPGAs are reconfigurable and can be implemented/updated using software only.

Other embodiments of the technologies can be implemented in numerous physical systems, such as optical systems, opto-electronic systems, or acoustic systems, where the logic signals can be present in either a physical medium (electromagnetic waves, pressure waves, etc.) or in the electronic elements used to measure such signals. Yet other embodiments of the disclosed technologies can be implemented in hybrid systems that combine electronic logic elements with other physical representations. In such systems, for example, optical delays can be made using the open-air transmission of photons and acoustic delays can be made using piezo-electric transducers and materials. These delays can serve as elements of a tunable jitter generator in accordance with this disclosure, where electronic sensors and detectors couple signals into and out of these other processing media.

Reference will now be made in detail to example embodiments of the disclosed technology that are illustrated in the accompanying drawings and disclosed herein. Wherever convenient, the same reference numbers will be used throughout the drawings to refer to the same or like parts.

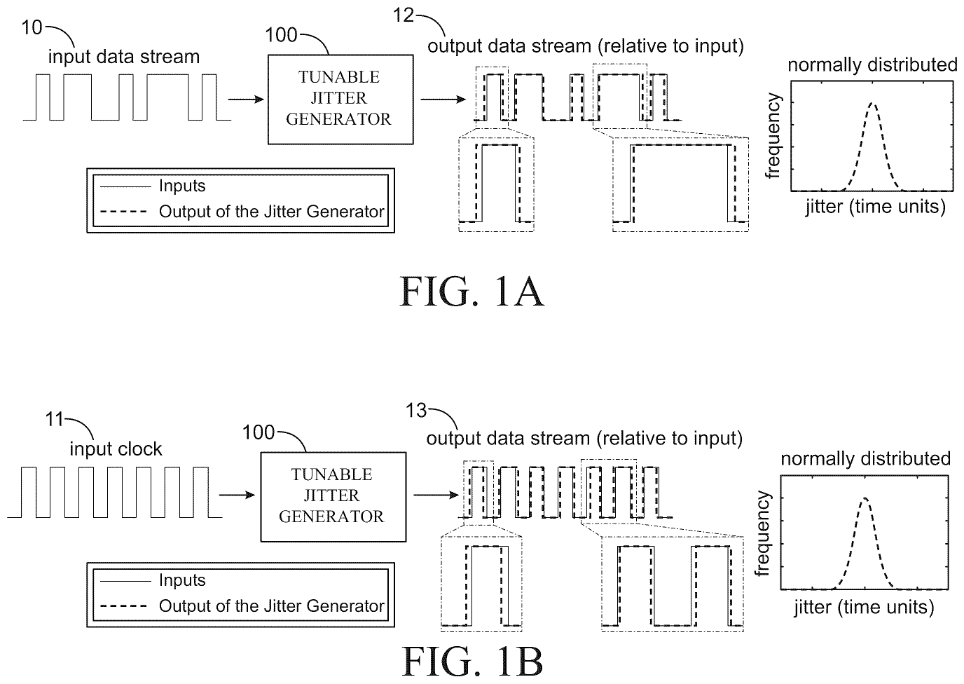

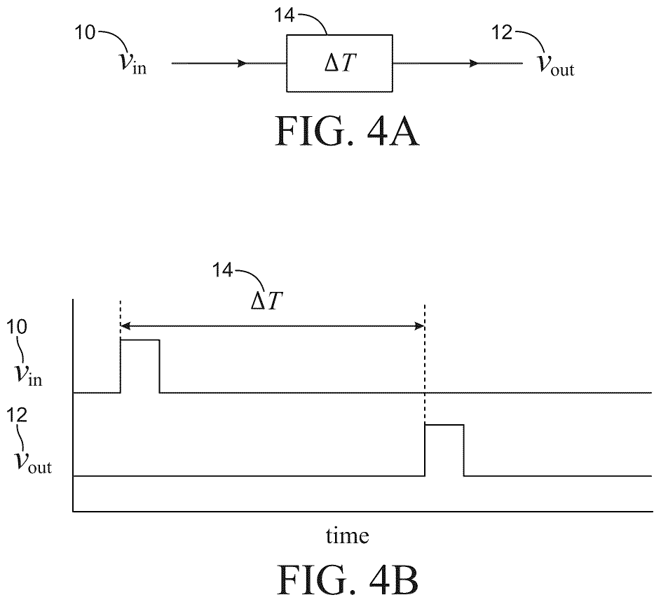

FIGS. 1A-1B depict an exemplary tunable jitter generator 100 for applying jitter to an input data stream (FIG. 1A) and an input clock (FIG. 1B), respectively. Tunable jitter generator 100 can be configured to receive an input data stream 10 or an input clock 11, and apply varied delays (e.g., jitter) to the rising and/or falling edges of the input data stream 10 or input clock 11. It should be understood that in each example in which this disclosure refers to input data stream 10, any of the disclosed embodiments of tunable jitter generator 100 can receive an input clock 11 in place of input data stream 10 and generate tunable jitter in substantially the same manner. As shown in FIGS. 1A-1B an input data stream 10 or input clock 11 can be received by tunable jitter generator 100. Tunable jitter generator 100 can produce an output data stream 12 that is jittered with respect to the input data stream 10. That is, the rising and/or falling edges of output data stream 12 can be out of phase (e.g., jittered) with respect to the input data stream 10 as shown in FIG. 1A. In a similar manner, tunable jitter generator 100 can produce an output clock 13 that is jittered with respect to the input clock 11. That is, the rising and/or falling edges of output clock 13 can be out of phase (e.g., jittered) with respect to the input clock 11 as shown in FIG. 1B. As shown in FIGS. 1A and 1B, output data stream 12 and output clock 13 include jitter that is normally distributed. In this regard, as known in the art, a normal distribution can be understood as a type of continuous probability distribution that is symmetrical around its mean with most values near the central peak of the distribution. A more in depth explanation of the structure of tunable jitter generator 100 and how tunable jitter generator 100 achieves normally distributed jitter is described with respect to FIGS. 4-11 below.

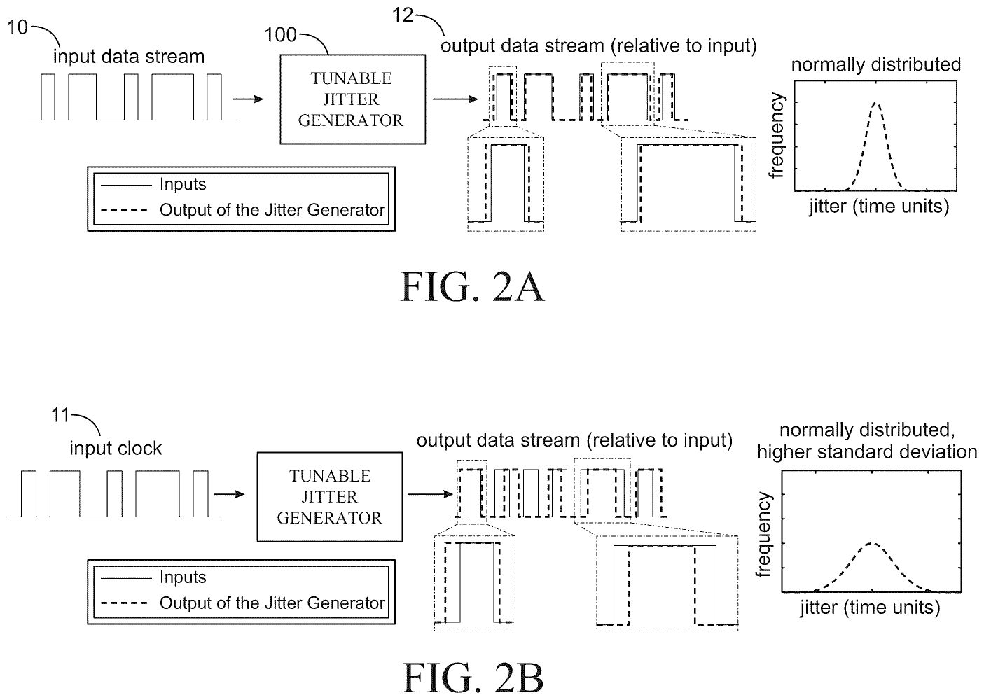

FIGS. 2A-2B depict an exemplary tunable jitter generator 100 for generating a first level of jitter and a second level of jitter. FIGS. 2A-2B show that tunable jitter generator 100 can be configured to provide varying levels of jitter on the rising and/or falling edges of an input data stream 10. Tunable jitter generator 100 can be tuned up or down to allow for lower levels of jitter (FIG. 2A) or higher levels of jitter (FIG. 2B) with respect to the input data stream 10. FIG. 2A shows tunable jitter generator 100 generating an output data stream 12 having a relatively lower level of jitter with respect to input data stream 10. Consequentially, the jitter of output data stream 12 in FIG. 2A has a low standard deviation as compared to the output data stream 12 shown in FIG. 2B. In comparison, FIG. 2B shows tunable jitter generator 100 generating an output data stream 12 having a relatively high level of jitter with respect to input data stream 10. Consequentially, the jitter of output data stream 12 in FIG. 2B has a high standard deviation as compared to the output data stream 12 shown in FIG. 2A. In other words, the distribution of output data stream 12 shown in FIG. 2A has a sharper peak with less values deviating from the mean of the distribution than the distribution of output data stream 12 shown in FIG. 2B. It should be noted that the standard deviation of both output data streams 12 follow a Gaussian distribution, which is a feature of the jitter generated by tunable jitter generator 100, unlike previously proposed jitter generation systems. It should be noted, that according to some examples, tunable jitter generator 100 is capable of producing jitter that is less than 1 ns (e.g., on the order of picoseconds). Accordingly, tunable jitter generator 100 can be useful in testing the robustness of communication systems that use optical or electrical data transfers, as described more fully below.

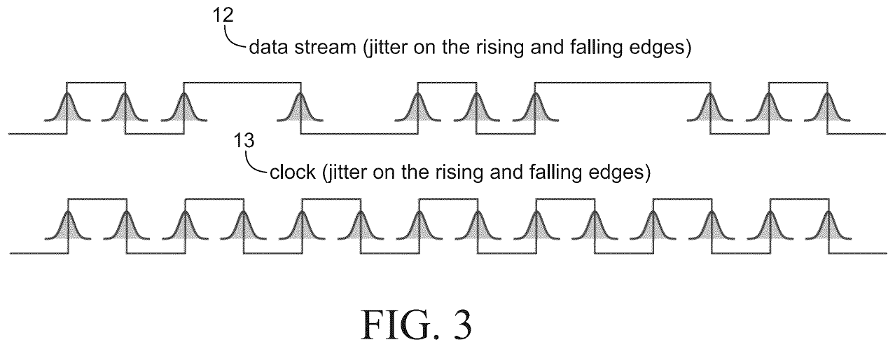

FIG. 3 illustrates output data stream 12 and output clock 13 that tunable jitter generator 100 is configured to output. As shown in FIG. 3, outputs 12, 13 from tunable jitter generator 100 have jitter applied to both the rising and the falling edges that follow a normal distribution relative to an input data stream 10 and an input clock 11, respectively. In other words, at each rising and falling edge of output data stream 12 and output clock 13, the output may deviate in phase from an input data stream 10 or input clock 11 in a normally distributed manner.

FIGS. 4-11 illustrate the building blocks of tunable jitter generator 100 in more detail and highlight how tunable jitter generator 100 is able to generate jitter that is normally distributed, according to aspects of the present disclosure.

More specifically, FIG. 4A is a block diagram illustrating a single logical element 14, AT, which can apply a delay to input data stream 10 (also interchangeably referred to as an input signal 10) to output an output data stream 12 (also interchangeably referred to as an output signal 12). FIG. 4A shows a continuous delay line (e.g., delay circuit) composed of the logical element 14. The continuous delay line is a structure that is capable of delaying input signal 10 to form output signal 12 (a delayed copy of input signal 10) without sampling and storing input signal 10 in memory. As shown, an input signal 10 is received by the logical element 14. Logical element 14 may then output the output signal 12. The waveform of output signal 12 may be substantially similar or identical to the waveform of input signal 10, except that the waveform of output signal 12 may be delayed in time with respect to the waveform of input signal 10. Note that output signal 12 is not jittered with respect to input signal 10. The delay shown in FIG. 4B can be attributable to the logical element 14. That is, the length (time delay) of the delay line is dependent on the physical properties of logical element 14 and can be proportional to the amount of time over which the input signal 10 is delayed. In some examples, the logical element 14 can be a transistor or a series of transistors that imparts a predictable time delay to input signal 10. In some examples, the logical element 14 can be a logic gate, such as a multiplexer logic gate (MUX), or a series of logic gates. Assuming that delayed output signals selectively routed through different components can be sampled and combined to generate tunable jitter, other example structures that can be used to implement logical element 14 include coaxial cables, printed circuit board traces, inductor-capacitor circuits, cascaded logic elements, and/or fiber optic cables.

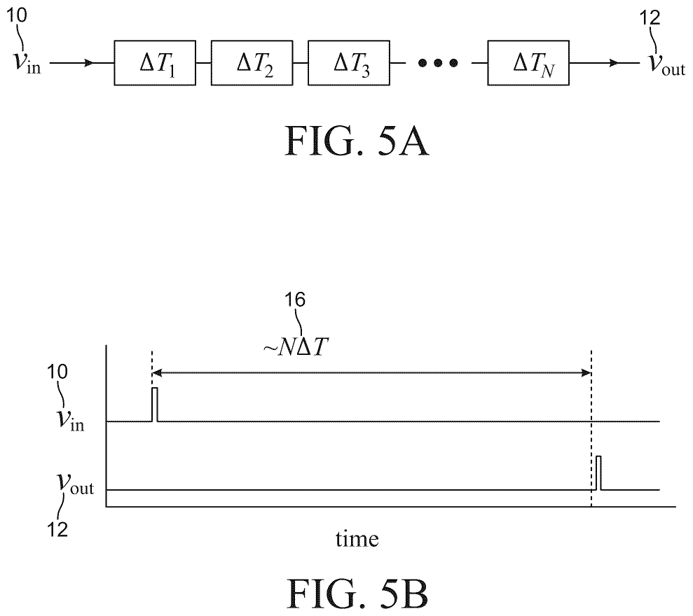

FIGS. 5A-5B show a similar delay line concept as FIGS. 4A-4B, except that the single logical element 14 ΔT is replaced with a cascade of logical elements 16, ˜NAT. FIGS. 5A-5B depict an input signal being delayed by a cascade of equivalent logical elements 16, according to aspects of the present disclosure. FIG. 5A shows N logical elements 14 (e.g., ΔT₁, ΔT₂, . . . , ΔT_{N}) that are connected in sequence to form a cascade of logical elements 16. Similar to FIG. 4B, in FIG. 5B, an input signal 10 is provided to the plurality of logical elements 16 which generate a delayed output signal 12. The waveform of output signal 12 may be substantially similar or identical to the waveform of input signal 10, except that the waveform of output signal 12 may be delayed in time with respect to the waveform of input signal 10. Note that output signal 12 is not jittered with respect to input signal 10 because output signal 12 is not out of phase with respect to input signal 10. The delay shown in FIG. 5B can be attributable to the cascade of logical elements 16. That is, the length (time delay) of the delay line is dependent on the physical properties of the cascade of logical elements 16 and can be proportional to the amount of time over which the input signal 10 is delayed. Because of manufacturing process variations, each of the logical elements 14 (e.g., ΔT₁, ΔT₂, . . . , ΔT_{N}) can cause a slightly different delay of ΔTₙ, where n is an index that tracks the n^{th} logical element 14 in the set of N logical elements. The output signals from the cascade of logical elements 16 (e.g., ˜NAT) can have a mean u and standard deviation o if each logical element 14 follows the same manufacturing process (e.g., are each made to cause a substantially similar delay). According to the central limit theorem, the average of many samples (observations) of a random variable (e.g., such as the delays caused by logical elements 14) with finite mean and variance is itself a random variable with a distribution that converges to a normal distribution as the number of samples increases. In other words, for a sufficiently large value of N, the delay of the outputs produced by the cascade of logical elements 16 (e.g., ˜NΔT) will be normally distributed. Tunable jitter generator 100 utilizes this characteristic of the cascade of logical elements 16 to generate tunable jitter that is normally distributed (e.g., by adding together a sufficiently large and randomly sampled number of logical elements 14). It should be understood that each logical element 14 (e.g., ΔT₁, ΔT₂, . . . , ΔT_{N}) defines a stage of a delay line and shall be referred to herein for simplicity of illustration as an “element stage.” For example, ΔT₁ can be considered a first element stage, ΔT₂ can be considered a second element stage, and ΔT_{N} can be considered an Nth element stage.

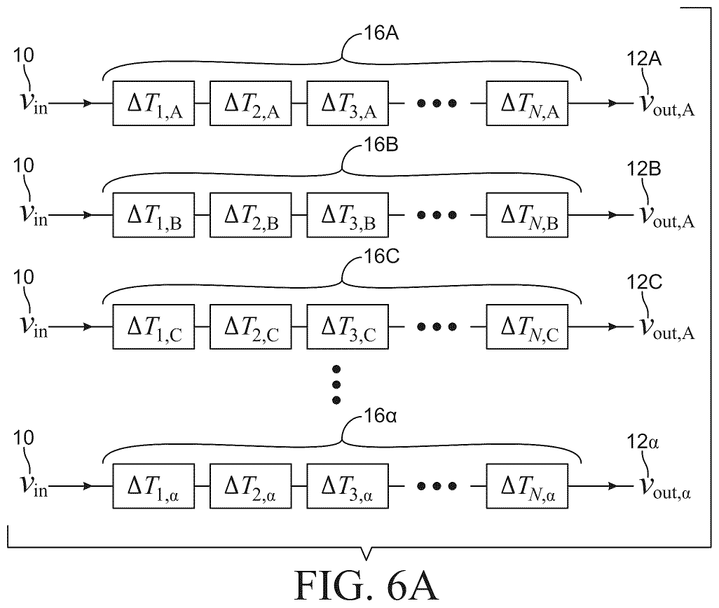

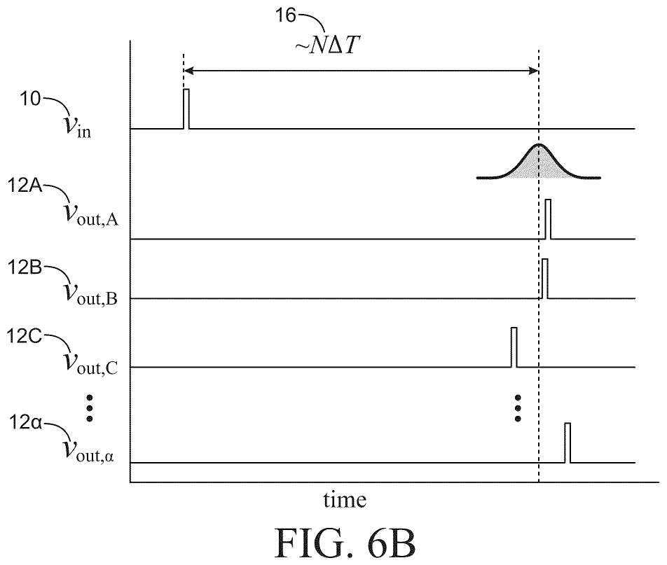

FIGS. 6A-6B expand upon the concepts introduced with respect to FIGS. 5A-5B. More specifically, FIG. 6A is a block diagram depicting an input signal being delayed by a randomly sampled (e.g., selected) cascade of approximately equivalent (e.g., having slight variations due to manufacturing differences) logical elements 14. It should be noted that in the given embodiment, every logical element 14 is designed to impart the same delay to the delay line, but in practice, small, random differences are present among each logical element 14 due to process variations. According to the central limit theorem, in such embodiments, the sum of the delays due to the cascade of logical elements 16 can impart normally distributed delays to the delay circuit. However, in other embodiments, it is possible for one logical element 14 (e.g., logical element 141) to impart a different delay from another logical element 14 (e.g., logical element 142). In such examples, the delays and resultant jitter may not be normally distributed, but can still be utilized to implement tunable jitter generator 100. Returning back to the example shown in FIGS. 6A-6B, these randomly selected approximately equivalent logical elements 14 are summed to form approximately equivalent cascades of logical elements 16. For example, input signal 10 may be fed into a first randomly sampled cascade of logical elements 16A (e.g., ΔT_{1,A}, ΔT_{2,A}, ΔT_{3,A}, . . . , ΔT_{N,A}) which causes an output signal 12A that is delayed with respect to the input signal 10. Similarly, input signal 10 may be fed into a second randomly sampled cascade of logical elements 16B (e.g., ΔT_{1,B}, ΔT_{2,B}, ΔT_{3,B}, . . . , ΔT_{N,B}) which causes an output signal 12B that is delayed with respect to the input signal 10. Because of the slight variations in each logical element 14, output signal 12B can have a different delay than output signal 12A. As shown in FIG. 6B, output signal 12B is slightly less delayed than output signal 12A. Similarly, input signal 10 may be fed into a third randomly sampled cascade of logical elements 16C (e.g., ΔT_{1,C}, ΔT_{2,C}, ΔT_{3,C}, . . . , ΔT_{N,C}) which causes an output signal 12C that is delayed with respect to the input signal 10. Because of the slight process variations in each logical element 14, output signal 12C can have a different delay than output signal 12A and the output signal 12B. As shown, output signal 12C is less delayed than both output signal 12A and output signal 12B. This process can be repeated an arbitrarily large number of times to create an arbitrary number of output signals 12. FIGS. 6A-6B shows input signal 10 may be fed into the α^{th} randomly sampled cascade of logical elements 16B (e.g., ΔT_{1,α}, ΔT_{2,α}, ΔT_{3,α}, . . . , ΔT_{N,α}) which causes an output signal 12x that is delayed with respect to the input signal 10. Because of the slight variations in each logical element 14, output signal 12a can have a different delay than output signal 12A, 12B, 12C, . . . , and 12(α−1). Average output signal 12 can be understood as a distribution of each output signal 12A, 12B, 12C, . . . , 12a. Output signal 12 is normally distributed based on the central limit theorem such that the delays of each output signal 12A, 12B, 12C, . . . , 12a are normally distributed. It should also be noted that each logical element in the same position within each cascade 16 can belong to the same element stage. For example, ΔT_{1,A}, ΔT_{1,B}, ΔT_{1,C}, . . . , ΔT_{1, α}, may all belong to the first element stage, and so on.

In order to efficiently select a sufficiently large number of logical elements to create delay lines yielding slightly different delays, certain disclosed embodiments can utilize a controller (discussed in more detail below) to generate random numbers and apply such numbers to the delay circuit to control which logical element of a respective element stage is selected for a path through the delay circuit. As used herein, “random number” may refer to a true random number or a pseudorandom number. In some examples, the random number generated by the controller can take the form of binary bits 24 which taken together are herein referred to as a binary vector 18. A binary vector 18 can have N entries of binary bits 24 that can be either a “1” or a “0.” As referred to above, the entries of the binary vector 18 can be used to define discrete paths through delay circuits comprising randomly sampled cascades of logical elements 16.

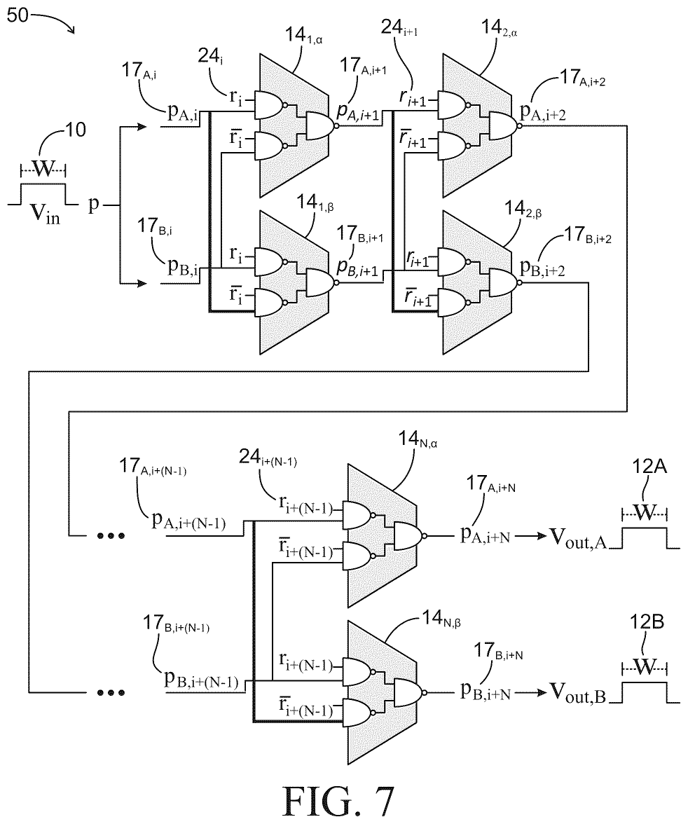

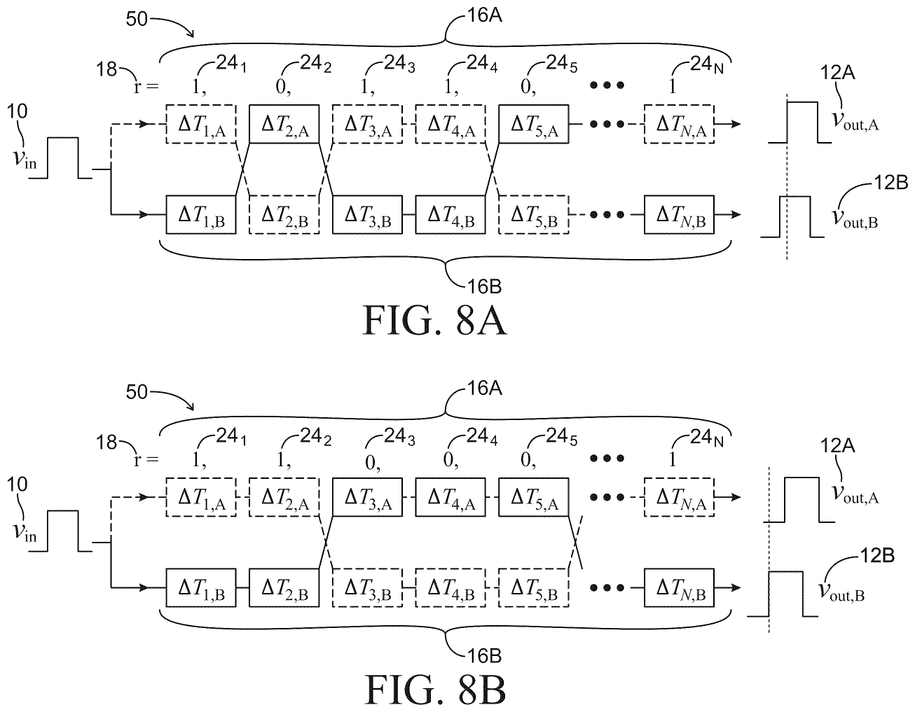

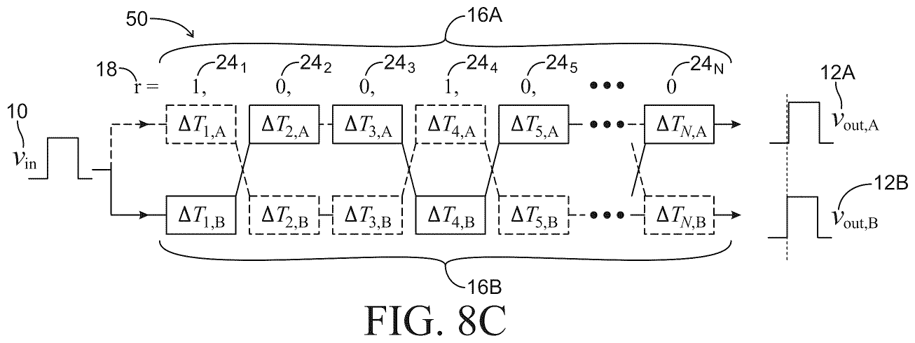

FIG. 7 depicts an exemplary Arbiter PUF 50 for adding delay to an input signal, according to an exemplary embodiment. Arbiter PUF 50 can be a component of the delay circuit of the tunable jitter generator 100 that provides output signals 12 (e.g., 12A, 12B) that impart varying delay values to an input signal 10 due to process variations in logical elements 14. As shown, Arbiter PUF may receive an input signal 10 having a pulse width p. The Arbiter PUF 50 may send a first version of input signal 10 down a first path as pulse 17_{A,i} and a second version of input signal 10 down a second path as pulse 17B.i. It should be noted that the first version and the second version of input signals 17_{A,i}, 17_{B,i} have the same pulse width as input signal 10 (e.g., are copies of input signal 10). Binary bits 24 control which path through the delay circuit the first version and the second version 17_{A,i}, 17_{B,i} take. For example, controller may provide binary bit 24; that controls which logical element is selected between 14_{1,α}, 14_{1,β}. Because 14_{1,α}, 14_{1,β} impart different delays due to process variations, intermediary outputs 17_{A,i+1}, 17_{B,i+1} have slightly different delays and may be offset in phase as compared to 17_{A,i}, 17_{B,i}. In a similar manner, binary bits 24ᵢ₊₁, . . . , 24_{i+(N-1)} control which path is taken by the first version and second version 17_{A,i}, 17_{B,i} through the delay circuit. The path selection is discussed in more detail with respect to FIGS. 8A-8C and FIGS. 9-10.

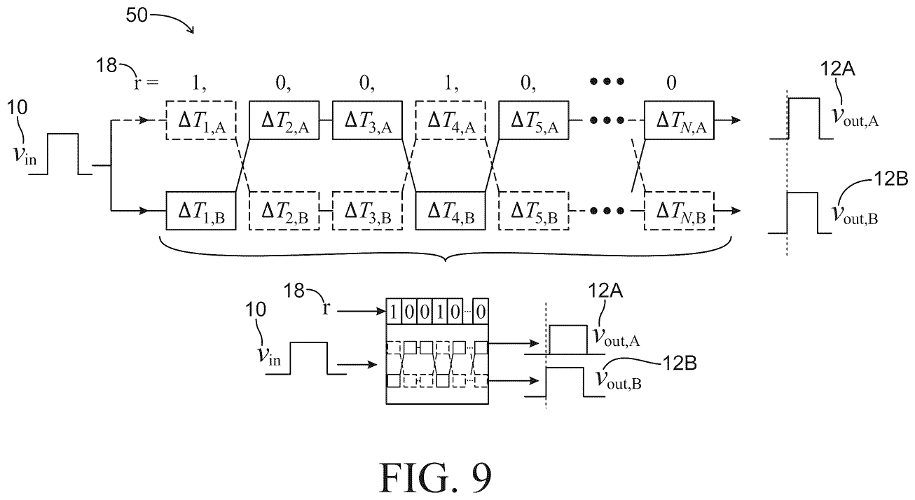

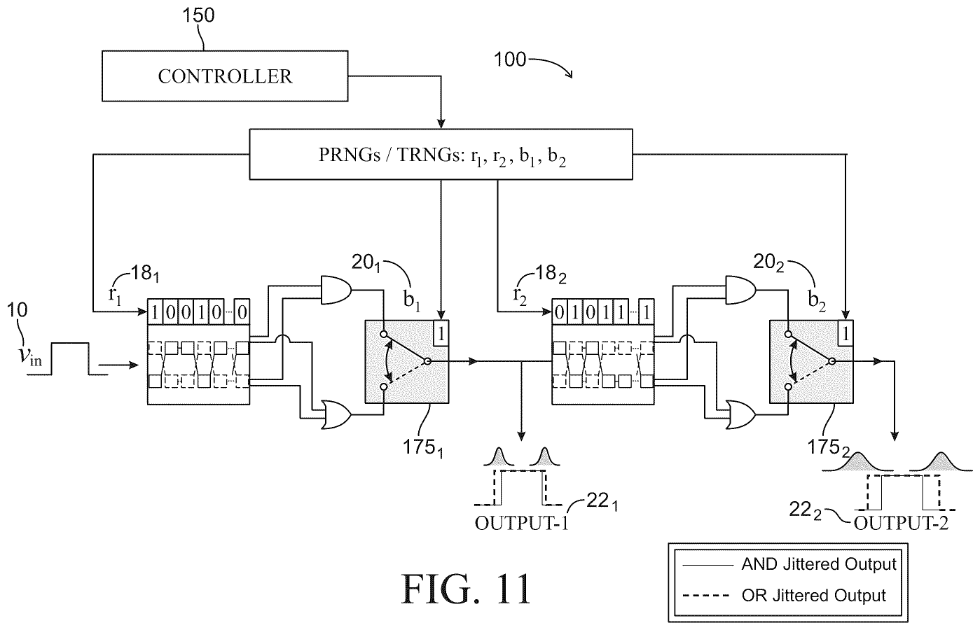

For example, FIG. 8A shows a delay circuit comprising a first delay line comprising a first cascade of logical elements 16A and a parallel delay line comprising a second cascade of logical elements 16B. It should be understood that the delay lines can be implemented as an Arbiter PUF 50 as described with respect to FIG. 7. Each of the entries of the binary vector 18 generated by the controller (e.g., controller 150, discussed with respect to FIG. 11) can determine how the discrete paths through the delay circuit are selected. Each of the entries of the binary vector can define a first discrete path through the delay circuit and a complementary second path through the delay circuit. For example, as shown in FIG. 8A, the first entry of the binary vector 18 (e.g., binary bit 241) is a “1” which defines a path through the first logical element ΔT_{1,A} and a complementary second path through ΔT_{1,B}. The second entry of the binary vector 18 (e.g., binary bit 242) is a “0” which defines a cross-wire between the two delay lines. Accordingly, the binary bit 242 entry of “0” logically connects ΔT_{1,A} to ΔT_{2,B} in the first path and connects ΔT_{1,B} to ΔT_{2,A} in the complementary second path. The third entry of the binary vector 18 (e.g., binary bit 243) is a “1” which would logically connect ΔT_{2,B} with ΔT_{3,A} in the first path and ΔT_{2,A} to ΔT_{3,B} in the complementary second path. The binary vector 18 extends to the Nth entry (e.g., binary bit 24N), thereby fully defining two discrete paths through the delay circuit comprising the parallel first cascade of logical elements 16A and the second cascade of logical elements 16B. The first path results in a first delayed output 12A and the second path results in a second delayed output 12B which is different in delay from the first delayed output because of the random selection of different logical elements 14 that make up the first cascade of logical elements 16A and the second cascade of logical elements 16B (e.g., different combinations of ΔT_{1,A}, ΔT_{2,A}, ΔT_{3,A}, . . . , ΔT_{N,A} and ΔT_{1,B}, ΔT_{2,B}, ΔT_{3,B}, . . . , ΔT_{N,B}). It should be understood that output signals 12A, 12B may be referred to as first and second versions of input signal 10, respectively, because output signals 12A and 12B have the same pulse width as input signal 10 and may differ from input signal 10 because of the delay introduced to output signal 12A by the first cascade of logical elements 16A and the delay introduced to output signal 12B by the second cascade of logical elements 16B. FIG. 8B is similar to FIG. 8A, but shows discrete paths that are different from those shown in FIG. 8A due to having a different binary vector 18 that defines different paths through the first and second cascade of logical elements 16A, 16B. FIG. 8C is similar to FIG. 8B and FIG. 8A, but shows discrete paths that are different from those shown in FIGS. 8A-8B due to having a different binary vector 18 that defines different paths through the first and second cascade of logical elements 16A, 16B. It should be noted that each output signal 12 shown in FIGS. 8A-8C imparts a varied delay to the input signal 10. For cascades of logical elements that include “N” elements, 2N different delay paths are possible. For sufficiently large values of “N”, the delays generated through this set of 2^{N} delay paths follows a normal distribution due to the central limit theorem. FIG. 9 is a simplified diagram of FIG. 8C, noting that the binary vector 18 defines the paths through the parallel cascades of logical elements 16A, 16B.

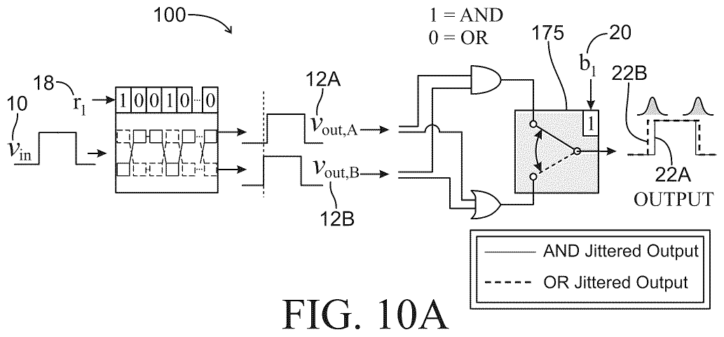

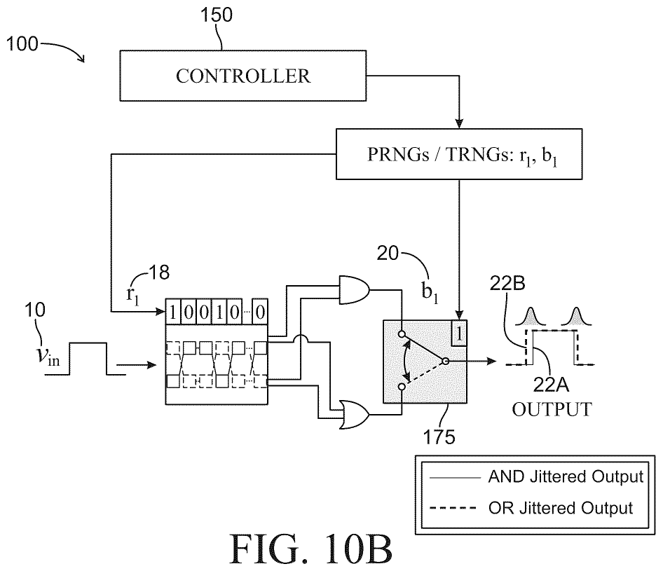

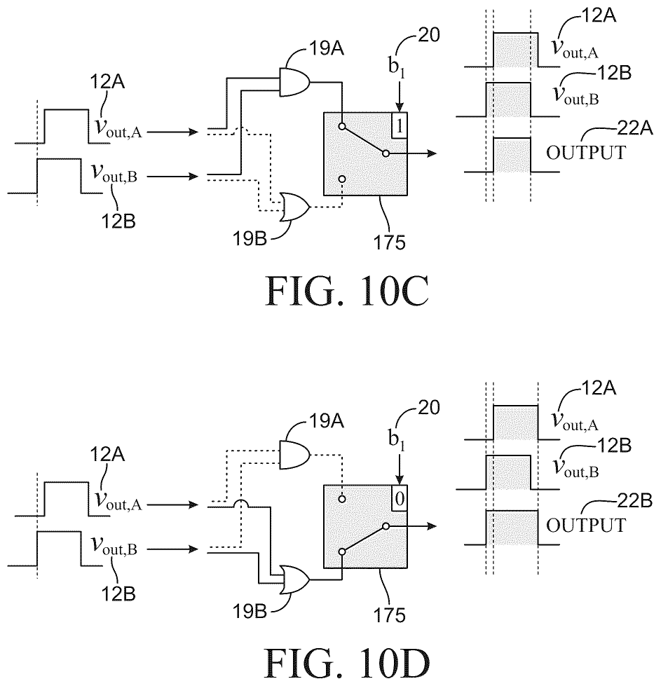

FIG. 10A depicts an exemplary jitter generator with a single generator stage, according to aspects of the present disclosure. FIG. 10A is similar to FIG. 9, with the addition of a combiner 175 and a random number generated by controller 150. In some examples, the random number can be provided to combiner 175 to control how output signals 12 are logically combined to form a jittered output signals 22A, 22B. In the present example, the random number generated by controller 150 can be represented as a binary register value 20. However, in other examples, the random number is not limited to binary values of “1” or “0.”

By randomly cycling the values of binary vector 18, it is possible to generate a plurality of different output signals 12 that are delayed in a normal distribution. This property can be used to create a tunable jitter generator (e.g., tunable jitter generator 100) that can impart normally distributed jitter to input data streams or data signals 10. To do so, the system should be able to make comparisons between the rising and falling edges of the two outputs signals 12A, 12B that are the result of the randomly selected binary vectors 18 defining discrete paths through the cascades of logic elements 16A, 16B. To make comparisons between output signals 12A, 12B, the controller can provide a random number such as a binary register value 20. Binary register value 20 can be randomly generated (e.g., by controller 150, as described below with respect to FIGS. 10B and 11) and provided to combiner 175, which is configured to logically combine the output signals 12A, 12B using a logical operator. In the present example, the binary register value can have a value of “0” or “1.” As shown in FIG. 10A, a binary register value 20 value of “1” can instruct combiner 175 to define an AND gate or, in other words, apply an AND operation to the output signals 12A, 12B. However, a binary register value 20 value of “0” can instruct combiner 175 to define an OR gate or, in other words, apply an OR operation to the output signals 12A, 12B. It should be noted that in certain examples, a binary register value 20 value of “1” can define an OR gate, while a binary register value 20 value of “0” can define an AND gate. As an example, as shown, the combiner 175 may comprise a switch that selects the output of an AND gate or an OR gate depending on the binary register value 20. Notably, the width of the output pulse is narrower if the AND gate is selected and wider if the OR gate is selected. By controlling such selection with a random number, further deviation in the timing of the output signal is provided. It should be understood that the system is not limited to the use of binary register values of “1” and “0” or only AND gates and OR gates. In some examples, the random number can have more values than just 1 and 0 and can instruct combiner 175 to define any number of logical gates, for example, a XOR gate, a NOT gate, a NAND gate, a NOR gate, etc. For example, in other embodiments, a value of “1” may instruct combiner 175 to define an AND gate, a value of “0” may instruct combiner 175 to define an OR gate, and a value of “2” may instruct combiner 175 to define a XOR gate, although other combinations of register values and logical gates are possible.

Returning to the example shown in FIG. 10A, depending on whether the generated binary register value 20 value is 0 or 1, the rising or falling edges of the output signals 12A, 12B can be selected by combiner 175. For example, as a result of the operations defined by combiner 175 (e.g., AND gate, OR gate, etc.), the rising edge of a first output signal is selected (e.g., output signal 12A) and the falling edge is selected from the second output signal (e.g., output signal 12B). Similarly, the falling edge can be selected from the first output signal (e.g., output signal 12A) and the rising edge can be selected from the second output signal (e.g., output signal 12B). In any case, when output signals 12A and 12B are associated with varied delays (e.g., due to process variations associated with logical elements 14), the width of the output signal 22 is changed to be either narrower (e.g., for an AND gate) or wider (for an OR gate) relative to the input signal 10. As an example, FIG. 10A shows jittered output 22A, which results from combiner 175 selecting for an AND gate and jittered output 22B, which results from combiner 175 for an OR gate. Accordingly, jittered output 22A is narrower than jittered output 22B. It should be noted output signals 22A, 22B are jittered because the selected rising edge and falling edge come from distinct output signals 12 that are delayed differently. For example, if output signal 12A and output signal 12B are delayed by the same amount with respect to input signal 10, then outputs 22A, 22B would not be jittered with respect to input signal 10. Accordingly, the binary register value 20 allows the system to impart normally distributed jitter onto both the rising and falling edges of the input signal 10 as described above. The resultant “jittered” output signals 22A, 22B is shown in FIG. 10A having jitter applied to both the rising and falling edges. The components shown in FIG. 10A can be understood as a single generator stage of a tunable jitter generator (e.g., a first generator stage of tunable jitter generator 100).

FIG. 10B depicts a simplified diagram of the exemplary single-stage jitter generator 100 of FIG. 10A, with the inclusion of controller 150. FIG. 10B depicts controller 150 that is configured to generate binary vector 18 that is used to define discrete paths through delay circuits of the single stage jitter generator 100. Controller 150 can also be configured to generate binary register value 20. Binary register value 20 can be provided to combiner 175, and based upon the value of binary register value 20, combiner 175 can be configured to control how output signals 12 (shown in FIG. 10A, but not in FIG. 10B) are logically combined to form a jittered output signals 22A, 22B.

FIG. 10C depicts two jittered signals that are combined with an AND gate. In the example shown, combiner 175 is provided with a binary register value 20 of “1” which may instruct combiner 175 to select for an AND gate 19A. Output signals 12A and 12B are provided to combiner 175 via AND gate 19A. Accordingly, jittered output signal 22A is generated. Note that due to the selection of AND gate 19A by combiner 175, jittered output 22A has a rising edge selected from output 12A and the falling edge selected from output 12B.

FIG. 10D depicts two jittered signals that are combined with an OR gate. In the example shown, combiner 175 is provided with a binary register value 20 of “0” which may instruct combiner 175 to select for an OR gate 19B. Output signals 12A and 12B are provided to combiner 175 via OR gate 19B. Accordingly, jittered output signal 22B is generated. Note that due to the selection of OR gate 19B by combiner 175, jittered output 22B has a rising edge selected from output 12B and the falling edge selected from output 12A. It should be noted that jittered output signal 22B has a pulse width wider than jittered output signal 22A.

FIG. 11 depicts an exemplary tunable jitter generator with two generator stages, according to aspects of the present disclosure. FIG. 11 includes the components shown in FIG. 10, but includes a second generator stage of a tunable jitter generator, which is substantially similar to the first generator stage of the tunable jitter generator. While the first generator stage of the tunable jitter generator is defined by random numbers generated by controller 150 (e.g., a first binary vector 18₁ and a first binary register value 20₁), the second generator stage of the tunable jitter generator is defined by other random numbers (e.g., second binary vector 18₂ and a second binary register value 20₂). The jittered output signal 22₁ resulting from combiner 175₁ of the first generator stage of the tunable jitter generator becomes the input of the second generator stage of the tunable jitter generator. Finally, the combiner 175₂ of the second generator stage of the tunable jitter generator outputs a second jittered output signal 222. The first binary vector 18₁, the second binary vector 18₂, the first binary register value 20₁ and the second binary register value 20₂ may all be generated by a controller 150. In some examples, controller 150 can include a random number generator. Controller 150 can be used to iteratively generate random numbers such as values for binary vectors 18 and binary register value 20 that facilitate applying normally distributed tunable jitter to an input signal 10. Controller 150 may also include circuitry that provides first random number and random numbers to components of the tunable jitter generator 100 in order to control which paths the input signal travels through the delay circuit. In some examples Controller 150 can be implemented in hardware or a combination of hardware and software. For example, controller 150 can include a processor in communication with a memory storing software instructions wherein the processor is configured to execute the software instructions to enable the functionality of controller 150. In the example shown in FIG. 11, first binary register value 20₁ is a “1” and defines an AND gate, while the second binary register value 20₂ is a “0” and defines an OR gate. It should be noted that the second jittered output signal 222 has more jitter than the first jittered output signal 22₁ relative to the input signal 10 because second jittered output signal 222 imparts additional jitter to already jittered first jittered output signal 22₁.

According to some examples, the controller 150, first generator stage of tunable jitter generator and the second generator stage of tunable jitter generator can be implemented in various types of circuits. For example, an FPGA may be programmed in software to implement the disclosed controller 150, first generator stage of tunable jitter generator, and the second generator stage of tunable jitter generator. The FPGA can be dynamically reprogrammed for different values of the binary vector 18 (e.g., first binary vector 18₁ and second binary vector 18₂) and for different values of binary register value 20 (e.g., first binary register value 20₁ and second binary register value 20₂). Other hardware may also be used to implement the architecture of FIG. 11. For example, the disclosed embodiment may be integrated into an ASIC chip to allow for internal testing of the chip.

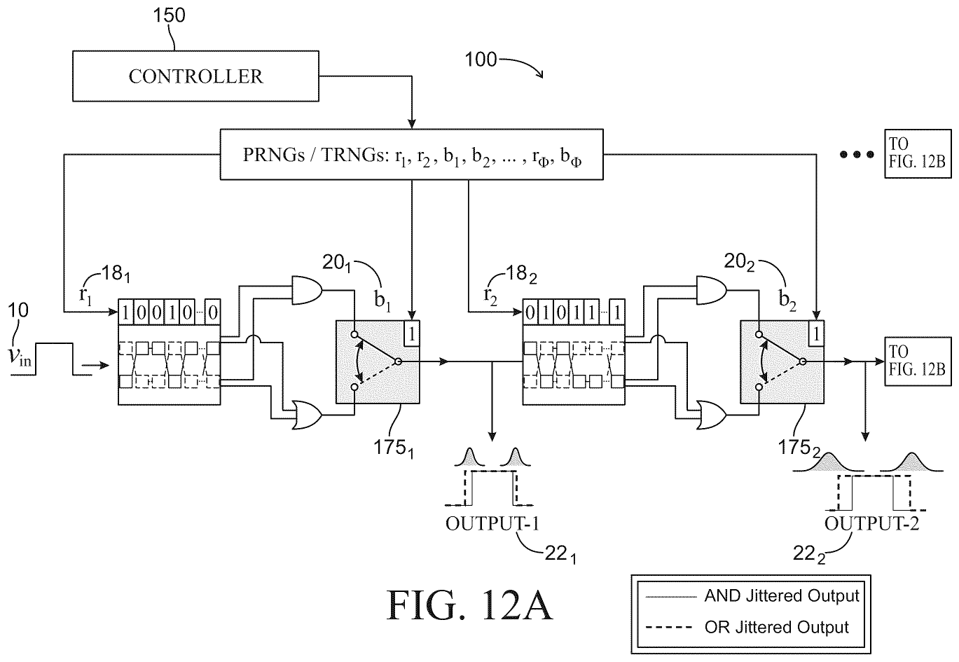

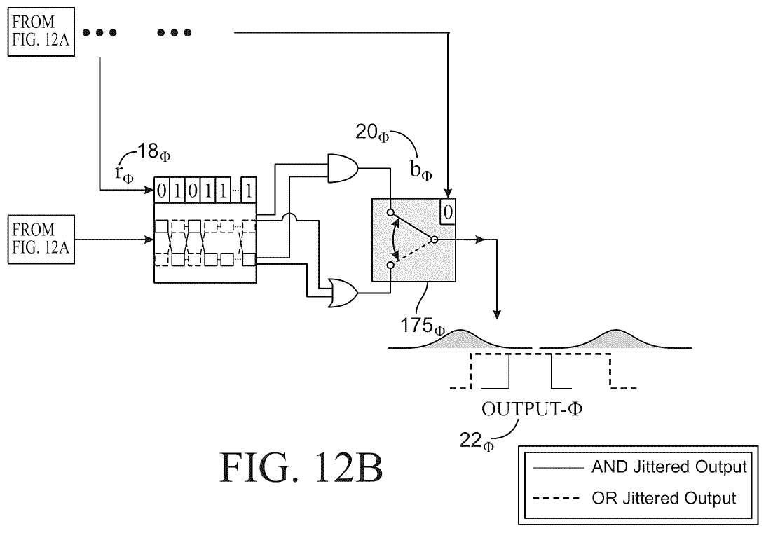

FIG. 12 depicts an exemplary tunable jitter generator 100 with multiple generator stages, according to aspects of the present disclosure. The architecture disclosed in FIG. 11 can be extended to include an arbitrary number of generator stages including a combiner 175 for each generator stage (e.g., 175₁, 175₂, . . . , 175_{Φ}). For example, FIG. 12 shows controller 150 that is configured to generate a @ number of binary vectors 18 (e.g., first binary vector 18₁, a second binary vector 18₂, . . . , Φ^{th} binary vector 18_{Φ}) where Φ is large. In some examples, the disclosed tunable jitter generator 100 can include 100 generator stages (e.g., Φ=100). As shown in FIG. 12, input signal 10 is fed into a first generator stage of tunable jitter generator 100. Controller 150 provides the first binary vector 18₁ to the first generator stage delay circuit and defines two complementary discrete paths through the delay circuit comprising cascades of logical elements 14 (as described in more detail with respect to FIGS. 8A-8C and FIG. 9) which provides two output signals (e.g., output signal 12A and output signal 12B). Controller 150 provides the first binary register value 20₁ to combiner 175₁ which defines a gate (e.g., an AND gate or an OR gate) that performs a logical combination on the two output signals (e.g., output signals 12A, 12B) from the first generator stage of the tunable jitter generator to yield a first jittered output 22₁ that has a first amount of jitter with respect to input signal 10. The first jittered output 22₁ can be provided as an input to the second stage of the tunable jitter generator 100. Controller 150 provides the second binary vector 18₂ to the delay circuit of the second generator stage of tunable jitter generator to define two complementary discrete paths through the delay circuit comprising cascades of logical elements 14 which provides two output signals. Controller 150 provides the second binary register value 20₂ to combiner 175₂ to define a gate which performs a logical combination on the two output signals from the second generator stage of the tunable jitter generator to yield a second jittered output 222 that has a second amount of jitter with respect to input signal 10. This process continues in a similar fashion. For example, the Φ^{th}−1 jittered output 22_{Φ-1} can be provided as an input to the Φ^{th} generator stage of the tunable jitter generator 100. Controller 150 provides the Φ^{th} binary vector 18_{Φ} to the Φ^{th} delay circuit of tunable jitter 100 which defines two complementary discrete paths through the delay circuit comprising cascades of logical elements 14 which provides two output signals. Controller 150 provides the Φ^{th} binary register value 20_{Φ} to combiner 175_{Φ} which defines a gate which performs a logical combination on the two output signals from the Φ^{th} generator stage of the tunable jitter generator to yield a Φ^{th} jittered output 22_{Φ} that has a Φ^{th} amount of jitter with respect to input signal 10. In this manner, tunable jitter generator is capable of producing normally distributed tunable jitter.

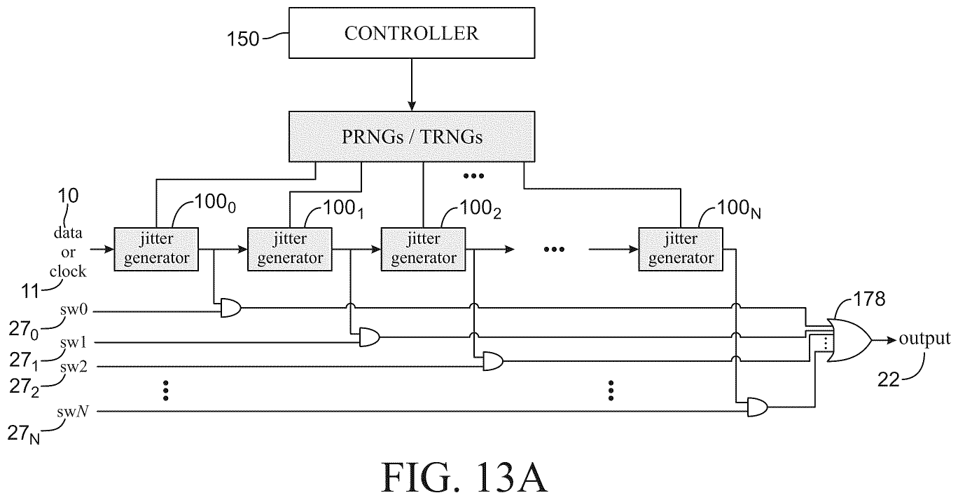

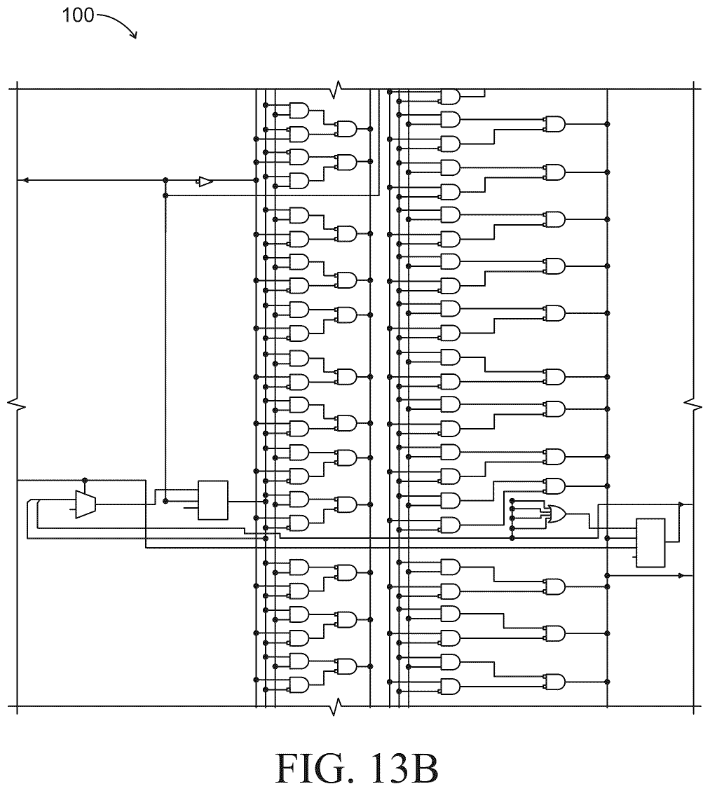

FIG. 13A depicts a cascade of tunable jitter generators 100 that can be implemented on an FPGA, according to aspects of the present disclosure. More specifically, FIG. 13A depicts a diagram of N+1 tunable jitter generators 100 cascaded together and implemented on an FPGA. For example, first tunable jitter generator 100₀ is shown connected in series to second tunable jitter generator 100₁. Second tunable jitter generator 100₁ is shown connected in series to third tunable jitter generator 100₂. As shown, an arbitrary number of tunable jitter generators 100 can be connected in series. FIG. 13A shows up to tunable jitter generators 100 connected in series up to tunable jitter generator 100_{N}. Controller 150 can be configured to provide binary vectors 18 defining discrete paths through the delay circuits of each tunable jitter generator 100₀-100_{N} and register values 20 that control the combiners 175 associated with each tunable jitter generator 100₀-100_{N}. Jitter can be sampled from any tunable jitter generator 100₀-100_{N}. For example, jittered output 220 from tunable jitter generator 100₀ can be fed into a first switch 27₀, jittered output 22₁ from tunable jitter generator 100₁ can be fed into a second switch 27₁, jittered output 222 from tunable jitter generator 100₂ can be fed into a third switch 27₂, and so on up through jittered output 22_{N} being fed into switch 27_{N}. Each switch 27₀-27_{N} can be connected to a combiner 178. Combiner 178 can be similar to combiner 175, except that combiner 178 can be configured to output any one jittered output 22₀-22_{N} that can be used as final jittered output 22. In some examples, combiner 178 can logically combine any number of jittered outputs 22₀-22_{N} to produce final jittered output 22. Additionally, jitter need not be sampled from only the final generator stage of any given multi-stage tunable jitter generator 100. In other words, jitter may be sampled from any generator stage (e.g., 1^{st}, 2^{nd}, . . . , N^{th}) of any tunable jitter generator 100₀-100_{N}. Like described above, such outputs can be logically combined by combiner 178 to form final jittered output 22. In some examples, controller 150 can be configured to provide a random number (e.g., a register value 20) that can instruct combiner 178 to logically combine any selected number of jittered outputs 22₀-22_{N} to form final jittered output 22. FIG. 13B shows a structure of an exemplary tunable jitter generator 100 implemented on an FPGA, as shown in FIG. 13A. Exemplary tunable jitter generator 100 is shown having 100 generator stages. That is, tunable jitter generator 100 can have 100 generator stages, where each generator stage is composed of a delay circuit comprising parallel cascades of logical elements 14 that are wired to allow an input signal to travel through two complementary discrete paths defined by a binary vector 18. The two outputs (e.g., output signals 12A, 12B) are fed into a combiner 175 which performs a logical operation on the output signals to generate a jittered output signal 22.

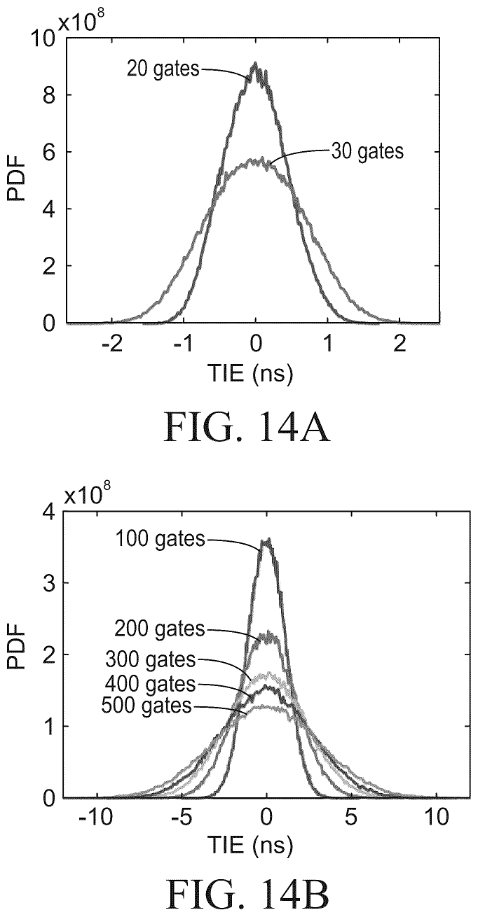

FIGS. 14A-14B depict jitter generated with exemplary jitter generators 100. More specifically, FIG. 14A depicts jitter generated by jitter generators 100 having 20 and 30 generator stages, respectively, and FIG. 14B depicts jitter generated by jitter generators 100 having 100, 200, 300, 400, and 500 generator stages, respectively. The x-axis shows a timing measurement called timing interval error (TIE), which is the difference between observed clock edge time and expected clock edge time for each clock edge present. This is best understood as a histogram of the observed TIE values, as shown to be generated by exemplary jitter generators 100. The y-axis shows the probability density function (PDF) associated with each jitter generator 100. As shown in FIGS. 14A-14B, jitter increases with the number of generator stages deployed as part of jitter generator 100 and the resultant jitter is normally distributed. The data shown in FIGS. 14A-14B was collected using an oscilloscope having 4 GHz analog bandwidth capable of 50 GSa/s, although oscilloscopes of varied bandwidth and sampling rates can be used to produce similar jitter measurements.

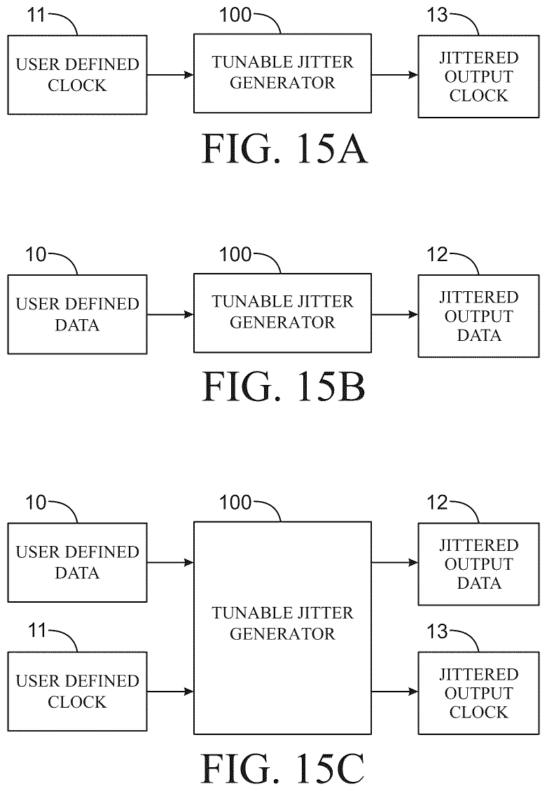

FIGS. 15A-21 depict various example applications for tunable jitter generator 100. FIGS. 15A-15C show applications of standalone tunable jitter generator 100. As shown in FIG. 15A, tunable jitter generator 100 is capable of receiving a user defined clock input 11 and outputting a jittered output clock 13. Similarly, in FIG. 15B, tunable jitter generator 100 can receive user defined data 10 and output jittered output data 12. In FIG. 15C, tunable jitter generator 100 can be configured to receive both user defined data 10 and user a user defined clock and output both jittered output data 12 and jittered output clock 13.

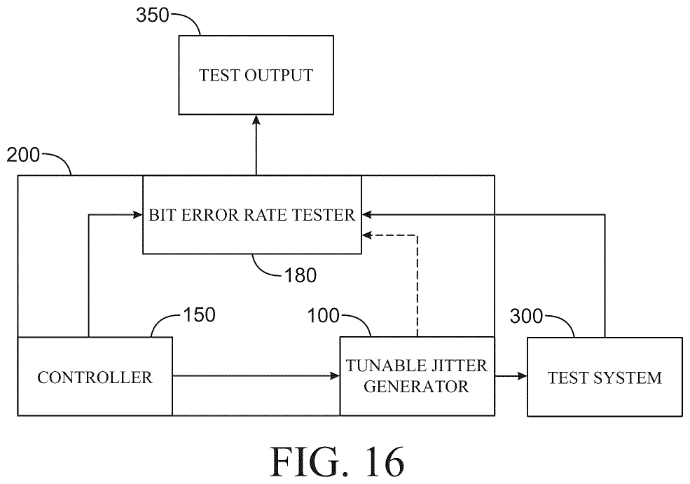

FIG. 16 depicts a self-contained bit error rate tester with an integrated tunable jitter generator and controller, according to aspects of the present disclosure. More specifically, FIG. 16 includes a jitter testing system 200. Jitter testing system 200 includes a controller 150, a tunable jitter generator 100, and a bit error rate tester 180. The jitter testing system 200 can be configured to test a test system 300. Jitter testing system 200 can be configured to provide a jittered signal to test system 300, and test how test system 300 works when fed a jittered signal. More specifically, controller 150 can create a random data stream (e.g., input signal 10), which may be provided directly to bit error rate tester 180 to act as a control signal that bit error rate tester 180 can compare to the output of the test system 300. The controller 150 can provide the same data stream (e.g., input signal 10) to the tunable jitter generator 100. Tunable jitter generator 100 can output a jittered output signal 22 which is provided to the test system 300. Test system provides an output to bit error rate tester 180. The bit error rate tester 180 is configured to provide a test output 350. Test output 350 may include one or more metrics that measure the performance of test system 300 given a jittered input (e.g., jittered output signal 22). For example, test output 350 can include a bit error rate, which can be understood as the ratio of bit errors to the total amount of bits in the transmitted data stream. In some examples, test output 350 can include a jitter profile that compares the Gaussian distributed jitter generated by tunable jitter generator 100 to the jitter profile of the output signal of test system 300. In such examples, bit error rate tester 180 may be configured to simultaneously measure the jitter profile of the output from tunable jitter generator 100 and the jitter profile of the output from test system 300 in order to generate test output 350. A jitter profile test output can help determine whether the Gaussian distributed jitter of tunable jitter 100 propagated through the system unchanged or if the jitter profile changes as the signal passes through test system 300. While FIG. 16 shows a single tunable jitter generator 100, any number of tunable jitter generators 100 can be included within the self-contained testing system 200 (e.g., tunable jitter generator 100₁, tunable jitter generator 100₂, . . . , tunable jitter generator 100_{N}).

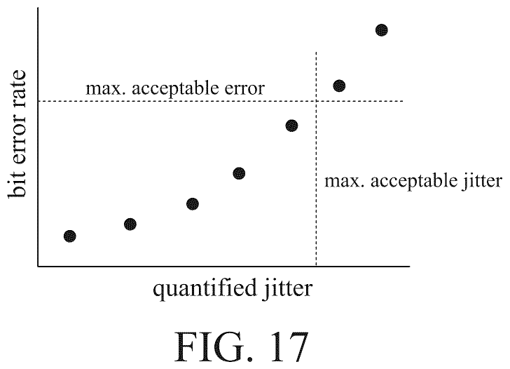

FIG. 17 depicts an exemplary test output curve, from a bit error rate tester, according to aspects of the present disclosure. More specifically, FIG. 17 depicts an exemplary test output (e.g., test output 350). Shown on the x axis is the quantified jitter present within the output from a test system (e.g., test system 300). Quantified jitter can be understood as any measure of jitter that a user is interested in monitoring. For example, quantified jitter can mean the variance of the jitter present within an output, the maximum deviation of jitter from the mean value of jitter within the output, the standard deviation of jitter present within the output, etc. Shown on the y axis is the bit error rate as a result of a given amount of jitter present within a signal received by the bit error rate tester 180. The dashed line extending from the y axis indicates a maximum acceptable bit error rate as determined by bit error rate tester 180 for test system 300. The dashed line extending from the x axis indicates the maximum amount of jitter that test system 300 can tolerate before the output signal breaks down.

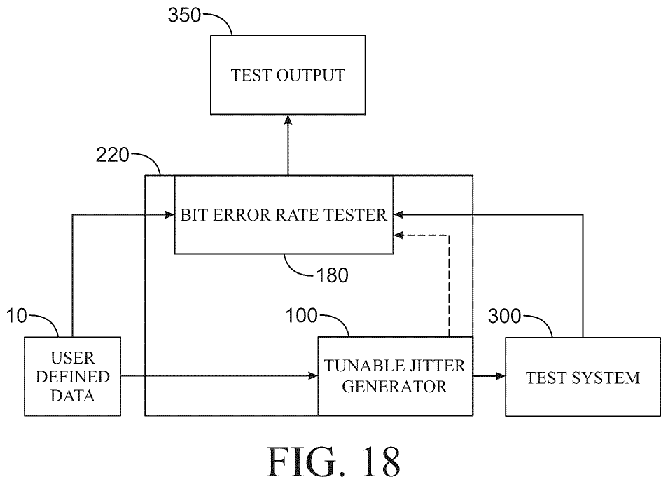

FIG. 18 depicts a bit error rate tester with an integrated tunable jitter generator configured to use user-defined data as an input, according to aspects of the present disclosure. More specifically, FIG. 18 depicts a jitter test system 220 that includes a bit error rate tester 180 and tunable jitter generator 100. User defined data 10 can be provided to bit error rate tester 180 to act as a control signal that bit error rate tester 180 can compare to the output of the test system 300. User defined data 10 can be provided to tunable jitter generator 100 to act as input data 10. Tunable jitter generator 100 can output a jittered output signal 22 that can be provided to test system 300 as an input signal. Test system 300 provides an output to bit error rate tester 180. The bit error rate tester 180 is configured to provide a test output 350. Test output 350 may include one or more metrics that measure the performance of test system 300 given a jittered input (e.g., jittered output signal 22). For example, test output 350 can include a bit error rate, which can be understood as the ratio of bit errors to the total amount of bits in the transmitted data stream. In some examples, test output 350 can include a jitter profile that compares the Gaussian distributed jitter generated by tunable jitter generator 100 to the jitter profile of the output signal of test system 300. In such examples, bit error rate tester 180 may be configured to simultaneously measure the jitter profile of the output from tunable jitter generator 100 and the jitter profile of the output from test system 300 in order to generate test output 350. A jitter profile test output can help determine whether the Gaussian distributed jitter of tunable jitter 100 propagated through the system unchanged or if the jitter profile changes as the signal passes through test system 300. While FIG. 18 shows a single tunable jitter generator 100, any number of tunable jitter generators 100 can be included within the jitter test system 22₀ (e.g., tunable jitter generator 100₁, tunable jitter generator 100₂, . . . , tunable jitter generator 100_{N}).

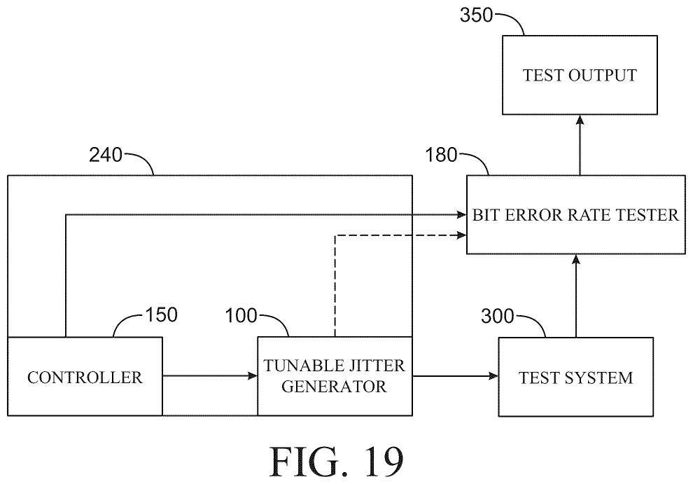

FIG. 19 depicts a controller and tunable jitter generator paired with a bit error rate tester configured to supply a data stream with and without jitter to evaluate the bit error rate of a test system, according to aspects of the present disclosure. More specifically, FIG. 19 depicts a jitter test system 240. Jitter test system 240 is similar to jitter test system 200, except that jitter test system 240 lacks an integrated bit error tester 180. Instead bit error tester 180 is external to jitter test system 240. Jitter test system can include a controller 150 and a tunable jitter generator 100. Controller 150 is configured to provide a random data stream (e.g., input signal 10) to bit error rate tester 180 to act as a control signal that bit error rate tester 180 can compare to the output of the test system 300. Controller 150 can also provide the same random data stream (e.g., input signal 10) to tunable jitter generator 100. Tunable jitter generator 100 can output a jittered output signal 22 that can be provided to test system 300 as an input signal. Test system 300 provides an output to bit error rate tester 180. The bit error rate tester 180 is configured to provide a test output 350. Test output 350 may include one or more metrics that measure the performance of test system 300 given a jittered input (e.g., jittered output signal 22). For example, test output 350 can include a bit error rate, which can be understood as the ratio of bit errors to the total amount of bits in the transmitted data stream. In some examples, test output 350 can include a jitter profile that compares the Gaussian distributed jitter generated by tunable jitter generator 100 to the jitter profile of the output signal of test system 300. In such examples, bit error rate tester 180 may be configured to simultaneously measure the jitter profile of the output from tunable jitter generator 100 and the jitter profile of the output from test system 300 in order to generate test output 350. A jitter profile test output can help determine whether the Gaussian distributed jitter of tunable jitter 100 propagated through the system unchanged or if the jitter profile changes as the signal passes through test system 300. While FIG. 19 shows a single tunable jitter generator 100, any number of tunable jitter generators 100 can be included within the jitter test system 240 (e.g., tunable jitter generator 100₁, tunable jitter generator 100₂, . . . , tunable jitter generator 100_{N}).

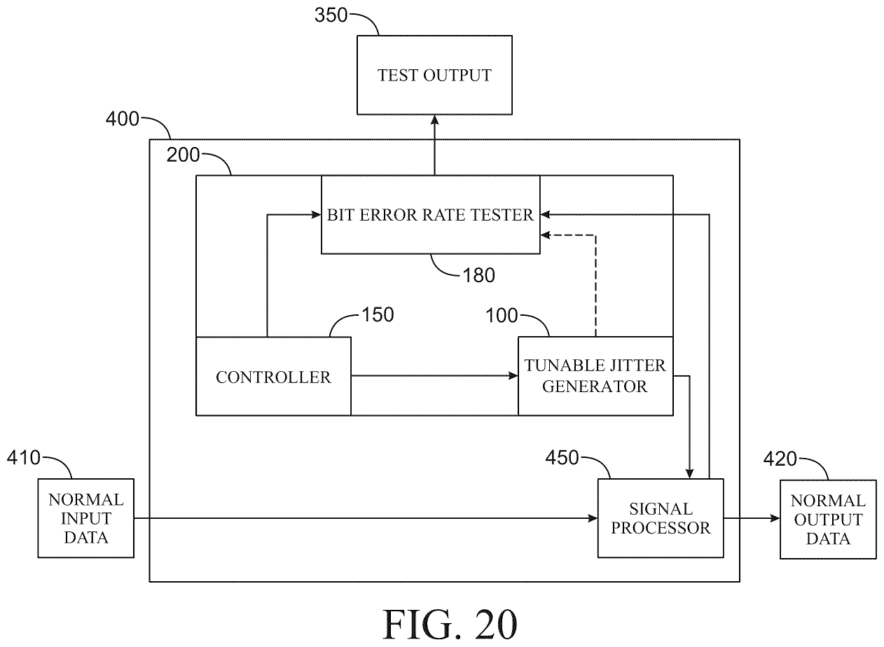

FIG. 20 depicts an integrated circuit with a built-in bit error rate tester, number generator, and tunable jitter generator configured for factory testing of a signal processor of the integrated circuit, according to aspects of the present disclosure. More specifically, FIG. 20 depicts integrated circuit 400. Integrated circuit 400 can include a jitter tester 200. As previously discussed with respect to FIG. 16, jitter tester 200 can include a Controller 150, tunable jitter generator 100, and bit error rate tester 180. Integrated circuit 400 can include a signal processor 450. According to some embodiments, signal processor 450 can be a communications signal processor, a digital signal processor, and the like. During normal operation the signal processer of integrated circuit 400 can receive normal input data 410 and output normal output data 450. However, it may be useful to have the ability to internally test whether components of integrated circuit 400 are operating appropriately without relying on external testing. Accordingly, to test integrated circuit 400, controller 150 can be configured to provide a random data stream (e.g., input signal 10) to bit error rate tester 180 to act as a control signal that bit error rate tester 180 can compare to the output of the signal processor 450. Controller 150 can also provide the same random data stream (e.g., input signal 10) to tunable jitter generator 100. Tunable jitter generator 100 can output a jittered output signal 22 that can be provided to signal processor 450 as an input signal. Signal processor 450 can provide an output to bit error rate tester 180. The bit error rate tester 180 is configured to provide a test output 350. Test output 350 may include one or more metrics that measure the performance of test system 300 given a jittered input (e.g., jittered output signal 22). For example, test output 350 can include a bit error rate, which can be understood as the ratio of bit errors to the total amount of bits in the transmitted data stream. In some examples, test output 350 can include a jitter profile that compares the Gaussian distributed jitter generated by tunable jitter generator 100 to the jitter profile of the output signal of signal processor 450. In such examples, bit error rate tester 180 may be configured to simultaneously measure the jitter profile of the output from tunable jitter generator 100 and the jitter profile of the output from signal processor 450 in order to generate test output 350. A jitter profile test output can help determine whether the Gaussian distributed jitter of tunable jitter 100 propagated through the system unchanged or if the jitter profile changes as the signal passes through signal processor 450. While FIG. 20 shows a single tunable jitter generator 100, any number of tunable jitter generators 100 can be included within the jitter test system 200 (e.g., tunable jitter generator 100₁, tunable jitter generator 100₂, . . . , tunable jitter generator 100_{N}).

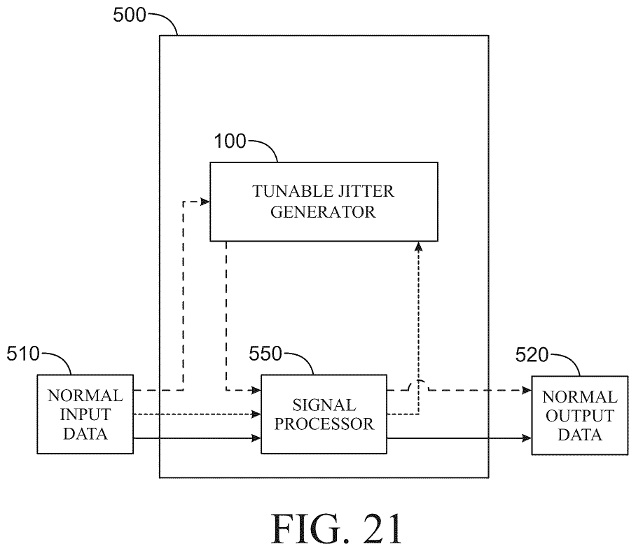

FIG. 21 depicts an integrated circuit with selectable paths for adding jitter before or after a signal processor to evaluate the maximum acceptable jitter on an input and to add jitter to the output, according to aspects of the present disclosure. More specifically, FIG. 21 depicts integrated circuit 500. Integrated circuit can include a signal processor 550 and a tunable jitter generator 100. According to some embodiments, signal processor 550 can be a communications signal processor, a digital signal processor, and the like. In a first regime of operation, shown with solid arrows, signal processor 550 can receive normal input data 510 and can generate output data 520. In a second regime of operation, shown in dashed arrows, the normal input data 510 can be provided to tunable jitter generator 100. Tunable jitter generator 100 can output a jittered output signal (e.g., output signal 22) that can then be provided to signal processor. Jittered output signal 22 can be similar to the normal input data 510 except for having jitter added by the tunable jitter generator 100. Signal processor 550 can receive the jittered output signal 22 from the tunable jitter generator 100 and generate output data 520. In the second regime, the output data 520 can be used to evaluate the maximum acceptable jitter before signal processor 550 ceases to properly operate. In a third regime, shown by the dotted lines, normal input data can be provided to signal processor 550. Signal processor can generate output data, which may be provided to the tunable jitter generator 100 as an input. The tunable jitter generator 100 can generate jittered output data 520 based on the output of the signal processor 550. In the third regime, the jittered output data 520 can be used for further downstream testing. While FIG. 21 shows a single tunable jitter generator 100, any number of tunable jitter generators 100 can be included within the integrated circuit 500 (e.g., tunable jitter generator 100₁, tunable jitter generator 100₂, . . . , tunable jitter generator 100_{N}).

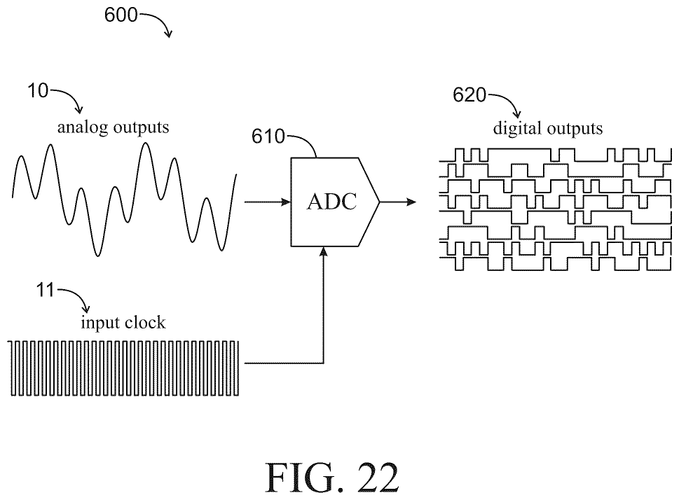

FIG. 22 depicts a simulated analog to digital converter (ADC) that samples analog content and outputs digital bits, according to aspects of the present disclosure. As discussed above, normally distributed jitter is critical for numerous applications, such as testing sensitive communication devices and interconnects, and aligning test results with theory and simulations. It can also be used to characterize the robustness of clock timing, phased-locked loops (PLLs), and the timing of data converters (ADCs and DACs). FIGS. 22-29 show various ways in which a tunable jitter generator 100 can be used to improve the functionality of ADCs that can impart spurious frequency content into a given signal. FIG. 22 shows an ADC 610 that receives an analog input 10 and an input clock 11 which is converted to digital output 620. Input clock 11 is typically a square wave signal that, on rising or falling edges, will cause logic gates in ADC 610 to update. In other words, the input clock 11 can control the physical sampling in the ADC 610 of analog input 10, thereby controlling the timing of information flow through ADC 610. The analog inputs 10 are flowing into ADC 610 that processes the analog content and outputs digital output 620. Digital output 620 serves as a static representation of the analog input 10 that can be stored in memory and examined or processed at a later time. It should be understood that the input clock 11 drives the physical sampling of update of the digital outputs 620, but the digital output 620 does not contain the time tags that provide the exact rising or falling times of the input clock 11. Instead, the time step between digital information updates is assumed to happen at evenly spaced intervals that are defined by the calibrated frequency of the input clock 11. In this regard, although input clock 11 is not perfect, the recorded digital information (e.g., digital output 620) assumes that time step between digital samples of digital output 620 is the same. Another common assumption for the operation of ADC 610 is that the input clock 11 satisfies the Nyquist sampling criterion-that the clock frequency is at least approximately four times higher than the maximum frequency that is desired to be accurately sampled using ADC 610. If the Nyquist sampling criterion is not satisfied for a given input clock 11, the digital output 620 from ADC 610 may suffer from aliasing, which introduces spurious frequency content. In some embodiments, tunable jitter generator 100 may be used to reduce spurious frequency content due to aliasing. According to some embodiments, various post processing steps may be used in addition to the use of tunable jitter generator 100 to reconstruct a non-aliased signal to achieve optimal results.

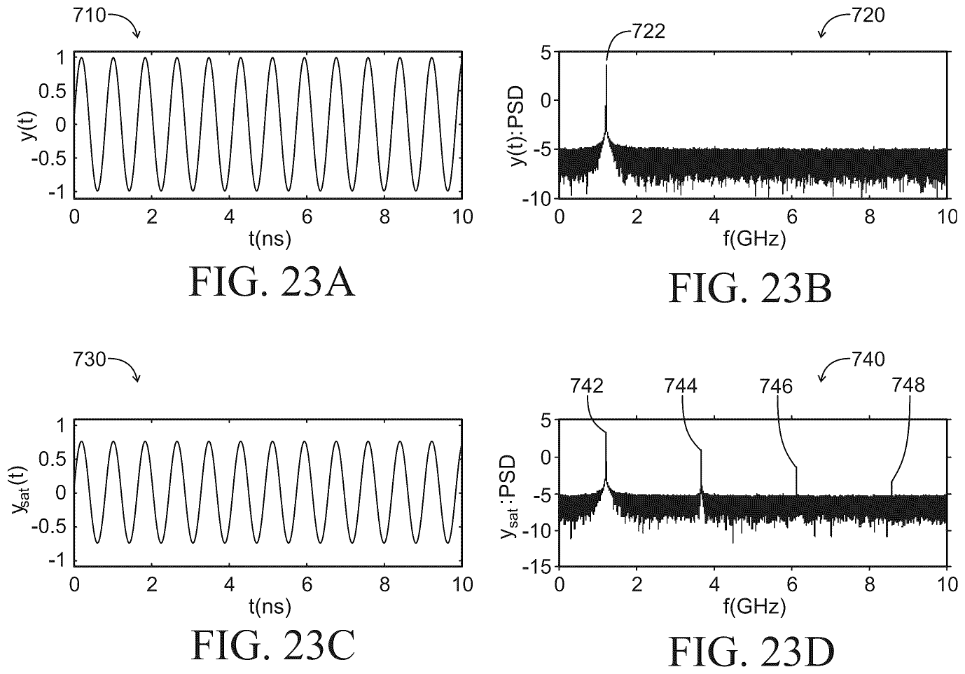

Another standard assumption in the operation of an ADC such as ADC 610 is that the analog hardware before and during the ADC sampling process do not impart nonlinear transformations on the analog signal content. In other words, it is assumed that the signal conditioning stages before an ADC and the ADC itself are linear components, meaning that they are assumed to not impart spurious frequency content into the signal (e.g., into digital output 620). FIGS. 23A-23D show an example of spurious signal content being introduced into a representative analog input. More specifically, FIG. 23A depicts a simulated time series of a sine wave 710 with a small amount of noise, and FIG. 23B depicts the power spectral density (PSD) 720 of sine wave 710. As shown in FIG. 23B, the sine wave exhibits a frequency peak 722 at the associated frequency of the sine wave 710.

Shown in FIG. 23C, sine wave 730 is formed by passing a simulated sine wave (e.g., sine wave 710) through a signal conditioning stage that mimics an amplifier with a slight amount of saturation (i.e., when the amplitude of the input sine wave 710 reaches the maximum allowable output of the amplifier). While sine wave 730 is visually similar to sine wave 710, the PSD 740 of the sine wave 730, shown in FIG. 23C, shows that sine wave 730 is different from sine wave 710. More specifically, PSD 740 includes peak 742 that is similar to peak 722 of PSD 720, but PSD 740 also includes spurious frequency peaks 744, 746, and 748 in addition to “real” frequency peak 742. Spurious frequency peaks 744, 746, and 748 mean that the amplifier is imparting spurious frequency content on the input. If the output of such an amplifier is what drives an ADC (e.g., ADC 610), the spurious frequency content will also be recorded as part of digital output 620. In post processing steps that make use of the digital output 620, it can be difficult to determine if spurious spectral content is real (i.e., correlates to a real frequency peak of an input signal) or a byproduct of the sampling process.

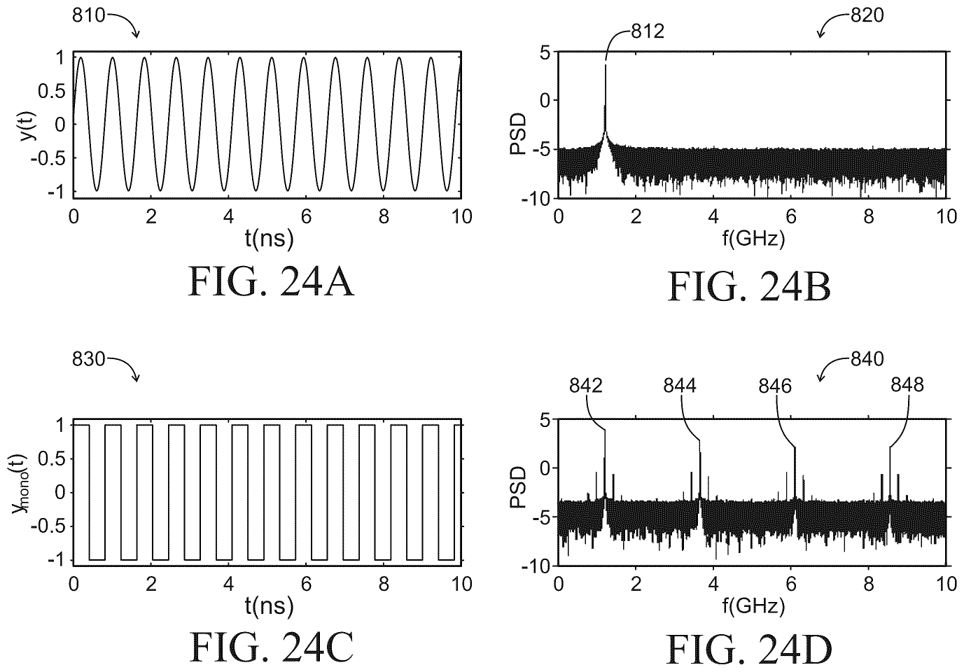

In another example, FIG. 24A depicts a simulated time series of a sine wave 810 with a small amount of noise, and FIG. 24B shows the corresponding PSD 820 that exhibits a real frequency peak 812 corresponding to the frequency of sine wave 810. FIG. 24C shows wave 830 that is the result of running sine wave 810 through a nonlinear signal conditioning stage known as a comparator, wherein the comparator outputs two states-high and low. This turns the ADC into a mono-bit receiver, where a single bit is stored at each update from the input clock. Mono-bit receivers are prevalent in the radar literature and can serve as low-cost and/or high-speed receivers for radio-frequency signal content. Similar to the saturating amplifier shown in FIGS. 23A-23D, the output information that is stored by a mono-bit receiver of FIGS. 24A-24D includes spurious frequency content. In this regard, FIG. 23D shows PSD 840 corresponding to wave 830. As shown in FIG. 23D, spurious frequency peak groupings 844, 846, and 848 all correspond to spurious frequency peaks. Frequency grouping 842 includes a central frequency peak that corresponds to real frequency peak 812, and a plurality of smaller peaks which are also associated with spurious frequencies. As will be described in more detail below, a tunable jitter generator (e.g., jitter generator 100) may be utilized to facilitate the removal of spurious frequency peaks such as those shown in FIGS. 23A-23D and FIGS. 24A-24D.

In certain embodiments consistent with the present disclosure, tunable jitter generator 100 can be used to remove spurious frequency content that is created during the sampling process as described with respect to FIGS. 22-24D. Using a tunable jitter generator 100, jitter can be introduced into input clock 11 to purposefully introduce timing variation in ADC 610. The timing variation can allow an ADC 610 to sample with a randomly distributed timing that is controllable (i.e., in a way that the timing variation can be selectively switched on or off) and that is tunable (i.e., the amount of variation from input clock 11 can be increased or decreased). Similar to as described with respect to FIG. 22, the output from an ADC with a jittered clock 13 are still digital bits that can be stored in static memory. In other words, no timing information about the exact times of clock rising or falling edges is stored and the frequency of the jittered input clock 13 is used for reconstruction. In this regard, using tunable jitter generator 100 to create a jittered clock 13 for use with an ADC 610 may raise the noise floor of a signal's frequency spectrum while simultaneously suppressing spurious frequency peaks. This is a tradeoff between signal to noise and spurious signal content, which is often defined on a case by case basis. In other words, different signals and background noise will tolerate different amounts of jitter on the clock. The tunability of jitter generator 100 enables the homing in on the correct parameter settings to select for the correct amount of jitter to minimize spurious peaks without overly impacting the signal to noise ratio of the output signal. However, it should be understood that adding jitter to the clock of an ADC using tunable jitter generator 100 as described herein does not necessarily depend on the jitter being tunable, digitally implemented, or normally distributed.

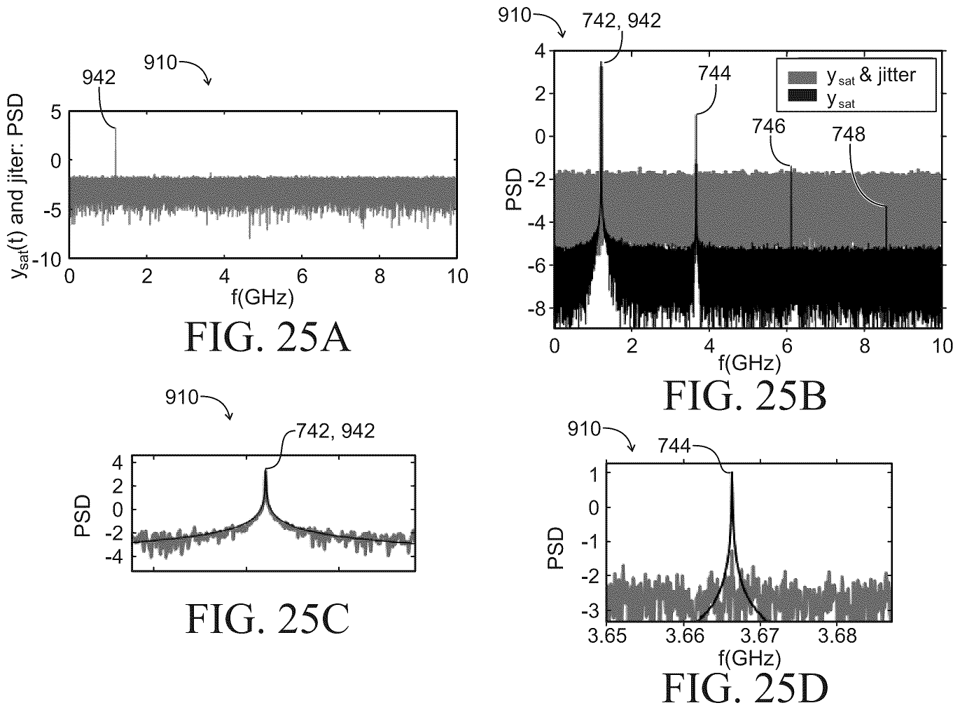

In one example, a jittered input clock 13 is introduced to the saturated sine wave of 730 of FIGS. 23C-23D as shown in FIG. 25A. In this example, the timing is perturbed by jittered clock 13, and the jittered clock 13 is normally distributed about the ideal regular timing of normal input clock 11. In other words, clock sampling times are now occurring both before and after the ideal clock times with a certain variance and the distribution has a mean of zero. After the sampling with the jittered timing, the analog information is stored as a static set of numbers, for example in an array or memory. This process is the same as for an ADC 610 with a normal input clock 11. The frequency spectrum (PSD) 910 of the resulting stored information in shown in FIG. 25A. As shown PSD 910 exhibits a frequency peak 942 that corresponds to peak 742 of FIG. 23D-both real peaks. FIG. 25B compares the PSD 910 to the PSD 740 of FIG. 23D. As shown, frequency peaks 942 and 742 match closely, while spurious peaks 744, 746, and 748 are suppressed in PSD 910. FIG. 25C shows a partial view of PSD 910 which shows frequency peak 942 compared to frequency peak 742 in greater detail. As shown, peak 942 which corresponds to a real frequency peak is retained. FIG. 25D shows a partial view of PSD 910 which shows that spurious peak 744 is suppressed. It should be noted that the noise floor of the PSD 910 is slightly elevated as compared to PSD 740 due to jittered clock 13, but with the benefit of suppressing the spurious peaks 744, 746, and 748.

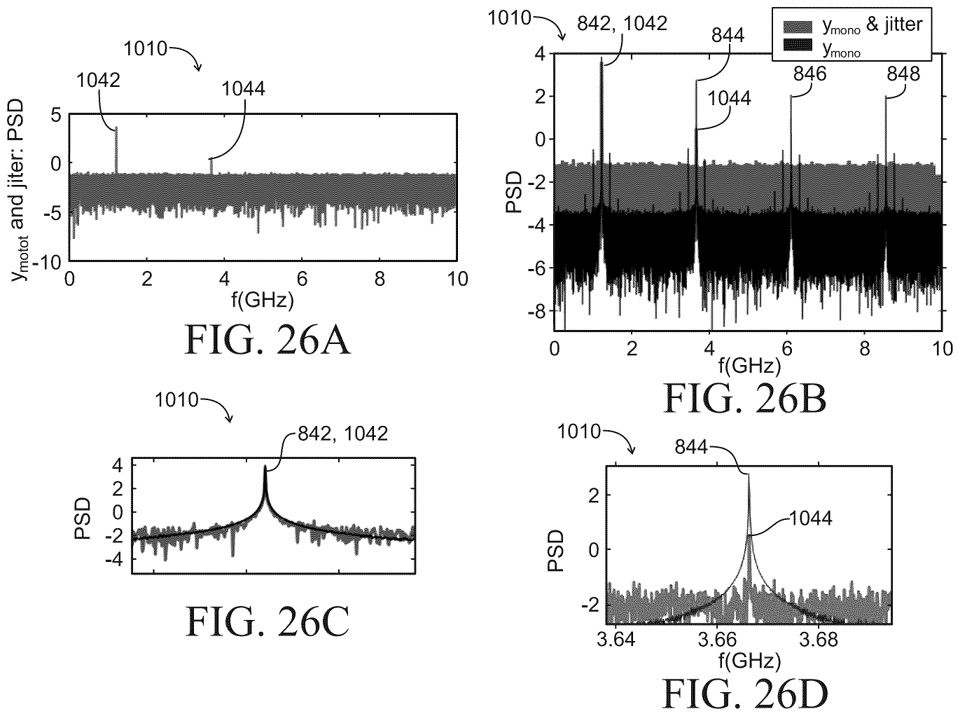

Similarly, in another example, a jittered input clock is introduced to the mono-bit receiver 830 of FIGS. 24C-24D, as shown in FIG. 26A. In this example, the timing is perturbed by jittered clock 13, and the jittered clock 13 is normally distributed about the ideal regular timing of normal input clock 11. In other words, clock sampling times are now occurring both before and after the idea clock times with a certain variance and the distribution has a mean of zero. After the sampling with the jittered timing, the analog information is stored as a static set of numbers, for example in an array or memory. This process is the same as for an ADC 610 with a normal input clock 11. The frequency spectrum (PSD) 1010 of the resulting stored information in shown in FIG. 26A. As shown, PSD 1010 exhibits a frequency peak 1042 that corresponds to peak 842 of FIG. 24D-both real peaks, and a partially suppressed frequency peak 1044 that corresponds to spurious peak 844.

FIG. 26B compares the PSD 1010 to the PSD 840 of FIG. 24D. As shown, real frequency peaks 1042 and 842 match closely, spurious peak 844 is partially suppressed as shown by peak 1044, and spurious peaks 846 and 848 are totally suppressed in PSD 1010. FIG. 26C shows a partial view of PSD 1010 which shows frequency peak 1042 compared to frequency peak 842 in greater detail. As shown, peak 1042 which corresponds to a real frequency peak is retained. FIG. 26D shows a partial view of PSD 1010 which shows that spurious peak 844 is partially suppressed as peak 1044. It should be noted that the noise floor of the PSD 1010 is slightly elevated as compared to PSD 840 due to jittered clock 13, but with the benefit of totally suppressing spurious peaks 846, and 848 and partially suppressing spurious peak 844.

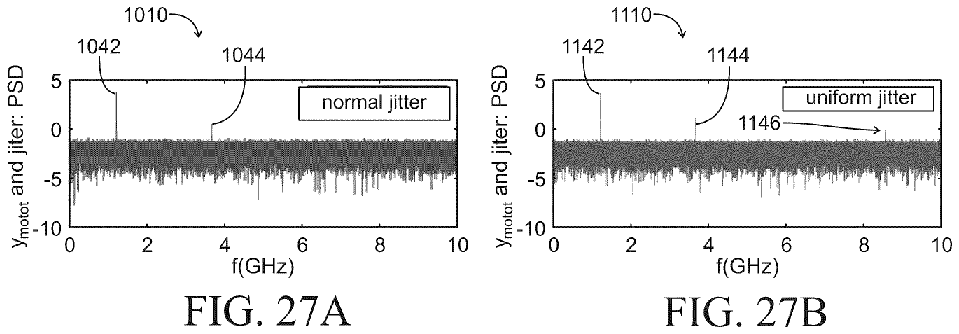

In another example, PSD 1010 is compared to a PSD 1110 in FIGS. 27A-27B. PSD 1110 is similar to PSD 1010, except that while PSD 1010 is generated using a jittered clock 13 with normally distributed jitter, PSD 1110 is generated using a jittered clock 13 with uniformly distributed jitter. For this particular example, normally-distributed jitter performs better at suppressing spurious peaks, but in other examples, uniformly distributed jitter (and/or jitter distributions) may perform better for other types of signals. It should be understood that there will be different types of jitter distributions that work better for spurious signal suppression depending on the type of waveform. As shown in FIG. 27A, PSD 1010 exhibits a real peak 1042 and a partially suppressed spurious peak 1044. In comparison, FIG. 27B shows PSD 1110 which exhibits a real peak 1142, a partially suppressed spurious peak 1144, and a partially suppressed spurious peak 1146.

According to some embodiments, there may be other ways to impart jitter using tunable jitter generator 100 to an ADC 610. Directly adding jitter to input clock 11 to form jittered clock 13 is only one representative method of imparting jitter to the sampling process of an ADC. The goal of this approach is to increase the diversity of physical sampling times about a timing reference signal, in this case, input clock 11. However, the use of tunable jitter generator to impart jitter to an ADC 610 is not expressly limited to the addition of jitter to an input clock to create a jittered clock 13.

Additionally, in some embodiments, it is beneficial to turn the jitter “on” and “off” while sampling and to denote in each dataset if jitter was present for the sampling. Other characteristics of the signal may also be collected, such as the distribution of jitter (e.g., normal, uniform, etc.), the variance of the jitter, and the clock frequency.

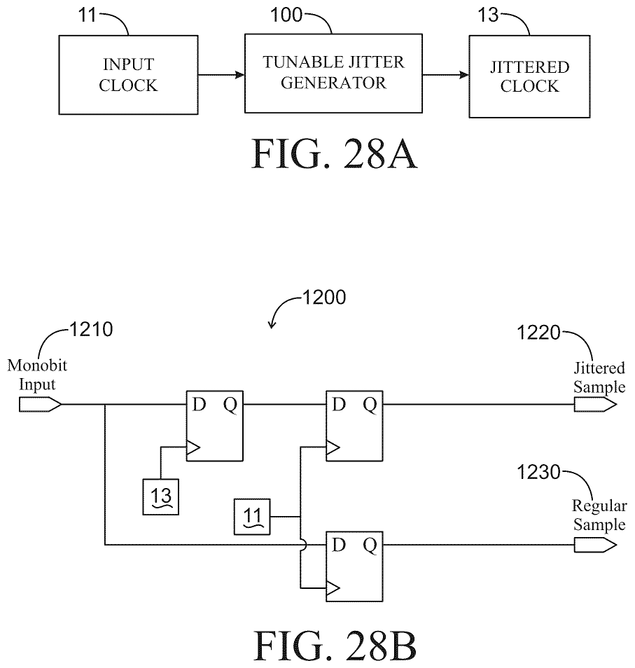

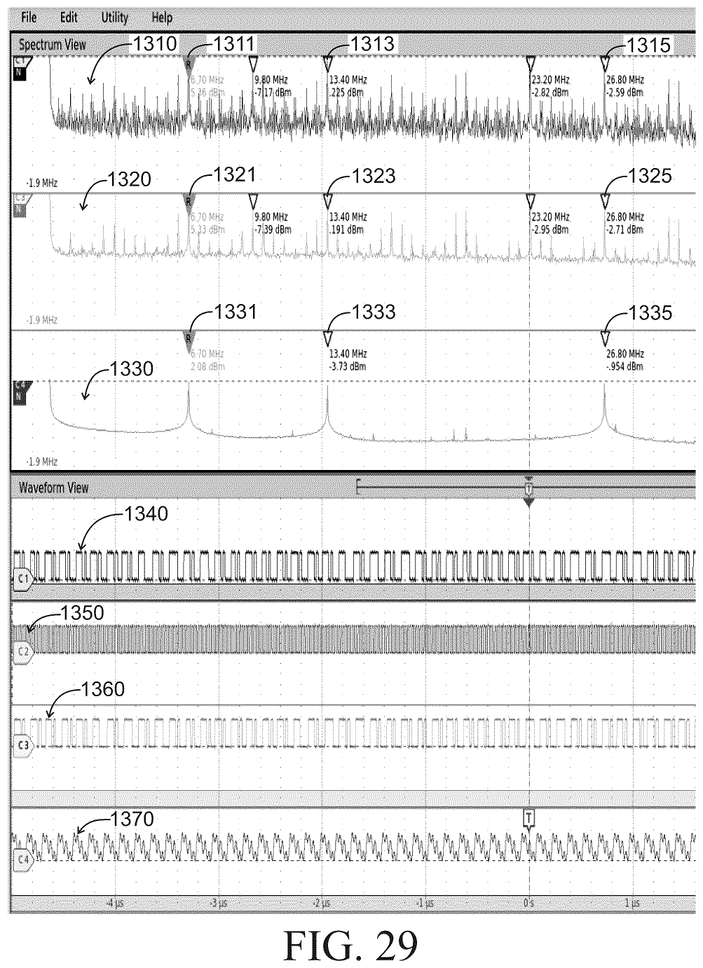

In another example, it is shown that tunable jitter generator 100 can be used to suppress spurious frequency content in a mono-bit receiver for a multi-frequency input signal. In this regard, a multi-frequency signal can be used as the input waveform and a conventional (non-jittered) mono-bit receiver can be used to induce spurs in between real, primary frequency components of the waveform. One purpose of this test is to show that spurious content may occur within the bandwidth of interest. Conventional methods, such as high-pass and/or low-pass filters are not effective at removing spurious frequency components that are within the same bandwidth as the signal of interest. However, as will be described in more detail below, tunable jitter generator is capable of suppressing such spurious frequency components. FIG. 28A shows how an input clock 11 can be converted to a jittered clock 13 using tunable jitter generator 13 for use with FPGA 1200. FIG. 28B shows an experimental setup using the input clock 11 and the jittered clocked 13 as inputs implemented within an FPGA 1200. The FPGA 1200 is used as the mono-bit receiver and the input buffer to the FPGA 1200 serves as the comparator that outputs a binary signal. The FPGA 1200 is able to latch the output of the comparator (e.g., the monobit input 1210) using both a non-jittered input clock 11 and the jittered input clock 13 to compare the two results in real time. The FPGA 1200 re-clocks both sets of latched data using a non-jittered clock and outputs the results to an oscilloscope. The time series and spectral (PSD) content of these waveforms are shown in FIG. 29.

The top portion of FIG. 29 shows the spectrum view (PSD) of the signals' frequency content and the bottom of FIG. 29 contains the waveform view with the signals' time series. PSD 1330 corresponds to the multi-frequency input to the monobit receiver. As shown, it contains real frequency components 1331, 1333, and 1335 at 6.7 MHz, 13.4 MHz, and 26.8 MHz, respectively, and waveform 1370 corresponds to the PSD 1330. PSD 1310 corresponds to the spectral content from the mono-bit receiver using a normal clock 11, and waveform 1340 corresponds to PSD 1310. PSD 1320 corresponds to the spectral content from the mono-bit receiver using the jittered clock 13, and waveform 1360 corresponds to PSD 1320. As shown, PSD 1310 includes real peaks 1311, 1313, and 1315 and many spurious peaks. In comparison, PSD 1320 also includes real peaks 1321, 1323, and 1325 but contains far fewer spurious peaks when compared to PSD 1310, showing the effectiveness of tunable jitter generator 100 in suppressing such spurious peaks. Both PSD 1310 and 1320 still contain spurs, but the data within PSD 1320 collected using jittered clock 13 is easier to examine and process. The noise floor of PSD 1320 is also slightly raised, but it is still below the amplitude of the frequency spurs that were suppressed. In other words, the amount of jitter selected in this example provides beneficial spur suppression while still maintaining a relatively low noise floor. Finally, waveform 1350 corresponds to the normal clock 11 that is used to re-clock the outputs. As used herein, re-clocking the outputs means to sample the outputs with a non-jittered clock (e.g., clock 11) after the output has been sampled with a jittered clock (e.g., jittered clock 13). Re-clocking the outputs may be useful in cases where a direct comparison between a jittered sample 1220 and the regular sample 1230 is to be made, for example on an oscilloscope screen as shown in FIG. 29. In some situations, it would not be necessary to apply non-jittered clock 11 after applying jittered clock 13 in order to “latch” the jittered samples into memory of an oscilloscope. However, to directly compare the results shown in FIG. 29 (e.g., PSD 1310 and associated waveform 1340 collected using normal clock 11 compared to PSD 1320 and associated waveform 1360 collected using jittered clock 13) it may be necessary to latch the waveforms to normal clock 11 (e.g., waveform 1350) so that the timing of the results shown on the oscilloscope is regularized, which is also representative to how the signals would be processed in downstream systems.

As described in the example above, a tunable jitter generator 100 can be built in FPGAs (e.g., FPGA 1200) using synthetized digital logic to enable a user to seamlessly impart jitter onto the FPGA clock. In some embodiments, one additional parameter that can be stored along with time series samples is the variance or standard deviation of the jitter. Tunable jitter generator 100 can produce normally distributed jitter with a tunable variance; additional jitter distributions can be used for this application, and ideally the jitter timing characteristics (e.g., timing interval error curves) are known a priori to imparting the jitter on a clock. According to some of the described embodiments, because the tunable jitter generator 100 imparts a well-known distribution (i.e., normal), models for this approach are easily implemented and tested in simulations before being physically implemented. The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. A system for introducing jitter to input signals, comprising:
a first delay circuit having a plurality of first element stages, the first delay circuit configured to receive an input signal and introduce jitter to the input signal thereby providing a jittered output signal, each of the first element stages defining a plurality of logical elements, wherein the first delay circuit is configured to transmit at least a first version of the input signal and a second version of the input signal through the first element stages such that the first version travels through first a path of the first delay circuit and the second version travels through a second path of the first delay circuit;
a controller configured to apply a random number to the plurality of first element stages, wherein each of the first element stages is configured to receive a respective portion of the random number and control which logical element of the respective first element stage processes the first version of the input signal and which logical element of the respective first element stage processes the second version of the input signal based on the portion of the random number received by the respective first element stage; and
a first combiner configured to receive the first version of the input signal and the second version of the input signal from the first delay circuit and to combine the first version and the second version thereby forming the first jittered output signal, wherein process variations in the plurality of first element stages cause random deviations in delays introduced by the first element stages of the first delay circuit.

2. The system of claim 1, further comprising:
a second delay circuit having a plurality of second element stages, the second delay circuit configured to receive the jittered output signal and introduce additional jitter to the jittered output signal thereby providing a second jittered output signal, each of the second element stages defining a plurality of logical elements, wherein the second delay circuit is configured to transmit at least a first version of the jittered output signal and a second version of the jittered output signal through the second element stages such that the first version travels through a first path of the second delay circuit and the second version travels through a second path of the second delay circuit;
wherein the controller is configured to apply a second random number to the plurality of second element stages of the second delay circuit;
wherein each of the second element stages of the second delay circuit is configured to receive a respective portion of the second random number and control which logical element of the respective second element stage processes the first version of the jittered output signal and which logical element of the respective second element stage processes the second version of the jittered output signal based on the portion of the random number received by the respective second element stage; and
a second combiner configured to receive the first version of the jittered output signal and the second version of the jittered output signal from the second delay circuit and to combine the first version of the jittered output signal and the second version of the jittered output signal thereby forming the second jittered output signal, wherein process variations in the plurality of second element stages cause random deviations in delays introduced by the second element stages of the second delay circuit.

3. The system of claim 2, further comprising one or more additional delay circuits each configured to provide an additional jittered output signal.

4. The system of claim 3, wherein each jittered output signal follows a Gaussian distribution.

5. The system of claim 1, wherein each of the delay circuit, the controller, and the combiner is implemented on a field programmable gate-array.

6. The system of claim 1, wherein the first jittered output signal comprises a jittered rising edge and a jittered falling edge.

7. The system of claim 6, wherein:
the jittered rising edge is selected from a first rising edge associated with the first version of the input signal and a second rising edge associated with the second version of the input signal;
the jittered falling edge is selected from a first falling edge associated with the first version of the input signal and a second falling edge associated with the second version of the input signal; and
wherein the jittered rising edge and the jittered falling edge are associated with distinct versions of the input signal.

8. The system of claim 1, wherein the controller is configured to apply a third random number to the first combiner.

9. The system of claim 8, wherein the first combiner combines the first version of the input signal and the second version of the input signal based on the third random number.

10. The system of claim 1, wherein the first combiner is configured to combine the first version of the input signal and the second version of the input signal using a function selected from an AND function and an OR function.

11. A method of generating tunable jitter, comprising:
randomly generating (i) one or more binary vectors and (ii) one or more binary register values;
selecting a first delay path comprising a first plurality of logical elements and a complementary second delay path comprising a second plurality of logical elements based on a first binary vector of the one or more binary vectors;
receiving an input signal;
providing the input signal to the first delay path and the complementary second delay path;
generating a first output signal from the first delay path and a second output signal from the second delay path; and
applying a first logical combination to the first output signal and the second output signal to generate a first jittered output signal, wherein the first logical combination is determined by a first binary register value of the one or more binary register values.

12. The method of claim 11, further comprising:
selecting a third delay path comprising a third plurality of logical elements and a complementary fourth delay path comprising a fourth plurality of logical elements based on a second binary vector of the one or more binary vectors;
providing the first jittered output signal to the third delay path and the complementary fourth delay path;
generating a third output signal from the third delay path and a fourth output signal from the fourth delay path; and
applying a second logical combination to the third output signal and the fourth output signal to generate a second jittered output signal, wherein second the logical combination is determined by a second binary register value of the one or more binary register values.

13. The method of claim 12, further comprising:
generating a plurality of additional binary vectors and a plurality of additional binary register values;
selecting additional delay paths based on the plurality of additional binary vectors;
generating a plurality of additional output signals from the additional delay paths; and
applying third logical combinations to the additional output signals to generate a plurality of additional jittered output signals, wherein the third logical combinations are determined by the plurality of additional binary register values of the one or more binary register values.

14. The method of claim 13, wherein the jittered output signals follow a Gaussian distribution.

15. The method of claim 13, wherein process variations in the logical elements forming each delay path cause random deviations in delays introduced by each delay path.

16. The method of claim 11, further comprising programming a field programmable gate-array to select the first delay path and the complementary second delay path and apply the logical combination to the first output signal and the second output signal.

17. The method of claim 11, wherein the logical combination is selected from an AND function and an OR function.

18. A system for introducing jitter to input signals, comprising:
a first delay circuit having a plurality of first element stages, the first delay circuit configured to receive an input signal and introduce jitter to the input signal thereby providing a jittered output signal, each of the first element stages defining a plurality of logical elements, wherein the first delay circuit is configured to transmit at least a first version of the input signal and a second version of the input signal through the first element stages such that the first version travels through first a path of the first delay circuit and the second version travels through a second path of the first delay circuit;
a second delay circuit having a plurality of second element stages, the second delay circuit configured to receive the jittered output signal and introduce additional jitter to the jittered output signal thereby providing a second jittered output signal, each of the second element stages defining a plurality of logical elements, wherein the second delay circuit is configured to transmit at least a first version of the jittered output signal and a second version of the jittered output signal through the second element stages such that the first version of the jittered output signal travels through first a path of the second delay circuit and the second version of the jittered output signal travels through a second path of the second delay circuit;
a controller configured to:
apply a first random number to the plurality of first element stages of the first delay circuit, wherein each element stage of the first element stages is configured to receive a respective portion of the first random number and control which logical element of the respective first element stage processes the first version of the input signal and which logical element of the respective first element stage processes the second version of the input signal based on the portion of the first random number received by the respective first element stage; and
apply a second random number to the plurality of second element stages of the second delay circuit, wherein each element stage of the second element stages is configured to receive a respective portion of the second random number and control which logical element of the respective second element stage processes the first version of the jittered output signal and which logical element of the respective second element stage processes the second version of the jittered output signal based on the portion of the second random number received by the respective second element stage;
a first combiner configured to receive the first version of the input signal and the second version of the input signal from the first delay circuit and to combine the first version and the second version thereby forming the jittered output signal;
a second combiner configured to receive the first version of the jittered output signal and the second version of the jittered output signal from the second delay circuit and to combine the first version and the second version thereby forming the second jittered output signal;
wherein process variations in the plurality of first stages cause random deviations in delays introduced by the first element stages of the first delay circuit; and
wherein process variations in the plurality of the second stages cause random deviations in delays introduced by the second element stages of the second delay circuit.

19. The system of claim 18, wherein the controller is configured to:
apply a third random number to the first combiner; and
apply a fourth random number to the second combiner.

20. The system of claim 19, wherein:
the first combiner combines the first version of the input signal and the second version of the input signal with a first function that is determined based on the third random number; and
the second combiner combines the first version of the jittered output signal and the second version of the jittered output signal with a second function that is determined based on the fourth random number.
